(19) United States
(12) Patent Application Publication
(10) Pub. No.: US 2026/0109373 A1
(43) Pub. Date: Apr. 23, 2026

(54) GENERATING LANE SEGMENTS USING EMBEDDINGS FOR AUTONOMOUS VEHICLE NAVIGATION

(71) Applicant: Tesla, Inc., Austin, TX (US)

(72) Inventors: Patrick CHO, Austin, TX (US); Ethan KNIGHT, Austin, TX (US); Tony DUAN, Austin, TX (US); Alex XIAO, Austin, TX (US); Jason LEE, Austin, TX (US); Ashok Kumar ELLUSWAMY, Austin, TX (US)

(73) Assignee: Tesla, Inc., Austin, TX (US)

(21) Appl. No.: 19/116,967

(22) PCT Filed: Sep. 29, 2023
(86) PCT No.: PCT/US2023/075632

§ 371 Date: Mar. 28, 2025

Related U.S. Application Data
(60) Provisional application No. 63/377,954, filed on Sep. 30, 2022.

(51) Int. Cl. B60W 60/00; B60W 50/00; B60W 50/14; G06N 20/00

(52) U.S. Cl. CPC B60W 60/001; B60W 50/00; B60W 50/14; G06N 20/00; B60W 2050/0028; B60W 2050/146; B60W 2552/10; B60W 2554/20; B60W 2556/40

(57) ABSTRACT

Presented herein are systems and methods for generating pathways for autonomously navigating through an environment. A computing system can identify a tensor comprising encodings derived from sensor data from an ego and map data defining a topology of an environment surrounding the ego. The computing system can determine, by applying at least a first portion of encodings to a machine learning (ML) model, a first index value defining a point within a first grid. The computing system can determine, by applying at least a second portion of encodings and the first index value to the ML model, a second index value defining the point within a second grid within the first grid. The computing system can generate a token for a pathway through the environment based on the first index value and the second index value for the point. The computing system can store a graph to include the token.

### CROSS-REFERENCE TO RELATED PATENT APPLICATIONS

The present application claims priority to U.S. Provisional Application No. 63/377,954, filed Sep. 30, 2022, which is incorporated herein by reference in its entirety for all purposes.

### TECHNICAL FIELD

The present disclosure generally relates to artificial intelligence-based modeling techniques to analyze image data and predict occupancy attributes for an ego's surroundings.

### BACKGROUND

Autonomous navigation technology used for autonomous vehicles and robots (collectively, egos) has become ubiquitous due to rapid advancements in computer technology. These advances allow for safer and more reliable autonomous navigation of egos. Egos often need to navigate through complex and dynamic environments and terrains that may include vehicles, traffic, pedestrians, cyclists, and various other static or dynamic obstacles. To navigate through such complex and dynamic environments, a computing system on an ego can execute path planning through the environment using sensor data on the surrounding environment. The path planning can identify a trajectory or a lane along which the ego is to traverse through the environment. Understanding the egos' surroundings is necessary for informed and competent decision-making to avoid collisions and to successfully execute path planning. Techniques to analyze and process the sensor data, however, may be bulky and too slow to be able to effectively navigate the ego through the environment.

### SUMMARY

To facilitate autonomous navigation of an ego (e.g., a vehicle or a robot) through an environment, a computing system of the ego can be configured with a trained artificial intelligence (AI) or a machine learning (ML) model. The ML model can obtain input from a set of embeddings encoding a lower-dimensional representation of sensor data (e.g., from video of the surrounding environment) and map data (e.g., navigation map of the environment). Using the input, the ML model can be used to generate a graph with a set of tokens defining a linguistic representation of potential lane segments within the environment that the ego can navigate. The graph can correspond to a sparse set of lane segments and their connectivity specified using coefficients (e.g., spline coefficients).

Aspects of the present disclosure of systems, methods, devices, apparatus, and non-transitory computer readable media for generating pathways for autonomously navigating through an environment. One or more processors can identify a tensor comprising a plurality of encodings derived from sensor data from an ego and map data defining a topology of an environment surrounding the ego. The one or more processors can determine, by applying at least a first portion of the plurality of encodings to a machine learning (ML) model, a first index value defining a point within a first plurality of points of a first grid defined over the environment. The one or more processors can determine, by applying at least a second portion of the plurality of encodings and the first index value to the ML model, a second index value defining the point within a second plurality of points of a second grid within a subset of the first plurality of points of the first grid. The one or more processors can generate a token for at least one of a plurality of pathways through the environment based on the first index value and the second index value for the point. The one or more processors can store a graph to include the token to be used to autonomously navigate the ego through the environment via one or more of the plurality of pathways.

In one embodiment, the one or more processors can classify, by applying the at least a third portion of the plurality of encodings and a third index value for a second point to the ML model, the second point as a continuation topology type dependent on the first point. The one or more processors can determine, responsive to the classification of the second point as the continuation topology type, a plurality of spline coefficients defining a path of the plurality of pathways between the first point and the second point through the environment. The one or more processors can generate a second token based on the third index point for the second point, the continuation topology type. The one or more processors can update the graph to include the second token and the plurality of spline coefficients to be used to be used to autonomously navigate the ego through the environment.

In another embodiment, the one or more processors can classify, by applying at least a third portion of the plurality of encodings and a third index value for a second point to the ML model, the second point as a forking topology type from the point relative to a third point. The one or more processors can determine, responsive to the classification of the second point as the termination topology type, a pathway defined by the first point and the second point through the environment. The one or more processors can generate a second token based on the third index point for the second point and the termination topology type. The one or more processors can update the graph to include the second token to be used to be used to autonomously navigate the ego through the environment.

In yet another embodiment, the one or more processors can identify a second graph comprising a plurality of tokens to be used to autonomously navigate a second ego through the environment via one or more of a second plurality of pathways. The one or more processors can determine, using the graph and the second graph, that at least one first pathway of the plurality of pathways for the ego intersects with at least one second pathway of the second plurality of pathways for the second ego. The one or more processors can perform an action on at least one of the ego or the second ego responsive to determining that at least one first pathway intersects with the second pathway.

In yet another embodiment, the one or more processors can identify, using the sensor data from the ego, a presence of a second ego stationary in the environment. The one or more processors can determine, using the graph, that at least one first pathway of the plurality of pathways for the ego intersects with the stationary second ego. In yet another embodiment, the one or more processors can classify, by applying at least a third portion of the plurality of encodings and the second index value to the ML model, the point as a topology type indicating a start of at least one of the plurality of pathways. The one or more processors can generate the token for at least one of the plurality of pathways through the environment based on the topology type.

In yet another embodiment, the one or more processors can determine, using a plurality of tokens of the graph, a trajectory defining navigation of the ego via a pathway of the plurality of pathways through the environment. In yet another embodiment, the one or more processors can present, via a graphical user interface (GUI), the graph defining the plurality of pathways relative to the topology of the environment surrounding the ego. In yet another embodiment, the one or more processors can generate the token using (i) a first embedding generated from the first index value, (ii) a second embedding generated from the second index value, and (iii) one or more embeddings associated with the point.

### BRIEF DESCRIPTION OF THE DRAWINGS

Non-limiting embodiments of the present disclosure are described by way of example concerning the accompanying figures, which are schematic and are not intended to be drawn to scale. Unless indicated as representing the background art, the figures represent aspects of the disclosure.

FIG. 1A illustrates components of an AI-enabled visual data analysis system, in accordance with an illustrative embodiment.

FIG. 1B illustrates various sensors associated with an ego, in accordance with an illustrative embodiment.

FIG. 1C illustrates the components of a vehicle, in accordance with an illustrative embodiment.

FIG. 2 illustrates a block diagram for a system of generating tensor representations of pathways for autonomously navigating through an environment, in accordance with an illustrative embodiment.

FIG. 3A-H each illustrates a block diagram of a process of generating pathways for autonomously navigating through an environment, in accordance with an illustrative embodiment.

FIG. 4 illustrates a diagram of a scenario in which a first ego uses a graph representing pathways to autonomously navigate through an environment, in accordance with an illustrative embodiment.

FIG. 5 illustrates a diagram of a scenario in which a first ego uses a graph to detect that a pathway that the first ego is traversing is to intersect a pathway that a second ego is about to traverse.

FIG. 6 illustrates a diagram of a scenario in which a first ego uses a graph to detect the presence of a stationary second ego in an environment, in accordance with an illustrative embodiment.

FIG. 7 illustrates a flow diagram of a method of generating pathways for autonomously navigating through an environment, in accordance with an illustrative embodiment.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting to the subject matter presented.

An ego can be an autonomous vehicle (e.g., car, truck, bus, motorcycle, all-terrain vehicle, cart), a robot, or other automated device. The ego can use one or more artificial intelligence (AI) algorithms or machine learning (ML) models to autonomously navigate the ego through an environment. To facilitate autonomous navigation, the ego can use a lane detection algorithm to recognize lane segments on a road of the environment as the ego traverses. For example, the ego can acquire sensor data (e.g., Light Detection and Ranging (LiDAR) and optical images) and apply an image segmentation model to detect lines along a road surface to recognize lane segments on the road. This approach, however, may be limited to detecting lane segments from a few different kinds of geometries, such as a single lane and its adjacent lanes along the road, with minimal capabilities to detect forks and merges. As a result, the image segmentation model may constrain the autonomous navigation of the ego to highly structured environments, such as highways with fewer lanes. Furthermore, it may be difficult, if not impossible, for the ego to rely on this type of model to autonomously navigate through more complex environments, such as intersections on local roads.

To address these and other technical constraints, a computing system on the ego can be configured with a set of AI algorithms and ML models to generate a graph defining a set of lane segments (sometimes referred to herein as pathways) and connectivity. To that end, the computing system on the ego can acquire sensor data (e.g., optical camera images and LiDAR) as well as map data (e.g., navigation map) of the surroundings of the ego. Using a first set of encoders, the computing system can generate a set of tensors (or embeddings) as a reduced dimensional representation of the sensor data. The computing system on the ego can enhance the set of tensors by applying a second set of encoders on the map data to add tensors to embed values related to the topology and road layouts. The resultant set of tensors can be a rich, dense representation of the surroundings of the ego.

With the output set of tensors, the computing system on the ego can apply a third set of encoders (e.g., an autoregressive decoder) to generate a set of tokens for the graph. Each token can define various properties of a point forming one or more of the lane segments through the environment. In applying the encoders to the set of tensors, the computing system can determine a first index value to define a position of the point defined within a coarse grid. Using the first index value, the computing system can calculate a second index value to define a position of the point within a finer grid. With the definitions of the points within the grids, the computing system can classify the point by a type of topology, such as a starting point, a continuation, a fork, or a terminal point, among others.

Continuing on, when the point is linked to another point (e.g., if classified as a continuation or a fork), the computing system can also identify the indexed value of the referenced point. The computing system can also calculate spline coefficients defining connectivity between the two points to define a corresponding lane segment through the environment. With the third set of encoders, the computing system can generate embeddings to represent the index values and the topology type, and then combine the embeddings to form the token to insert into the graph. By repeating this process, the computing system on the ego can generate the set of tokens for the graph to define a linguistic representation of potential lane segments within the environment that the ego can navigate. Using the lane segments defined by the graph, the ego can autonomously navigate through the environment.

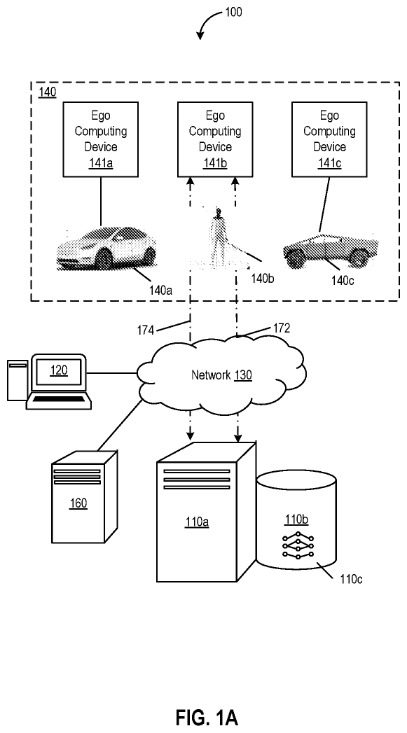

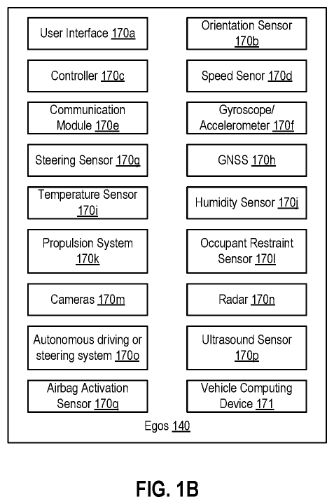

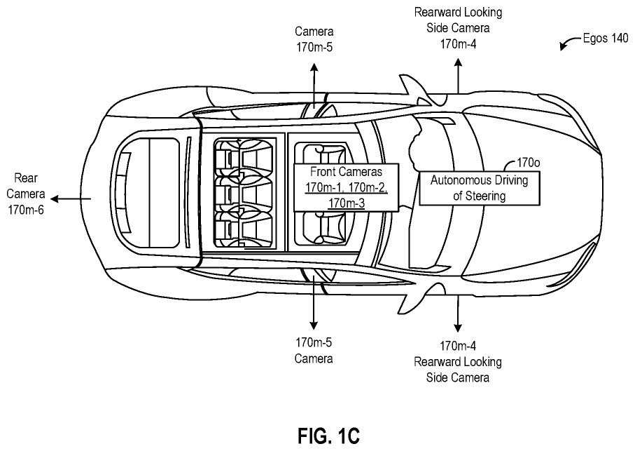

FIG. 1A is a non-limiting example of components of a system in which the methods and systems discussed herein can be implemented. For instance, an analytics server may train an AI model and use the trained AI model to generate an occupancy dataset and/or map for one or more egos. FIG. 1A illustrates components of an AI-enabled visual data analysis system 100. The system 100 may include an analytics server 110a, a system database 110b, an administrator computing device 120, egos 140a-b (collectively ego(s) 140), ego computing devices 141a-c (collectively ego computing devices 141), and a server 160. The system 100 is not confined to the components described herein and may include additional or other components not shown for brevity, which are to be considered within the scope of the embodiments described herein.

The components mentioned herein may be connected through a network 130. Examples of the network 130 may include, but are not limited to, private or public LAN, WLAN, MAN, WAN, and the Internet. The network 130 may include wired and/or wireless communications according to one or more standards and/or via one or more transport mediums.

The communication over the network 130 may be performed in accordance with various communication protocols such as Transmission Control Protocol and Internet Protocol (TCP/IP), User Datagram Protocol (UDP), and IEEE communication protocols. In one example, the network 130 may include wireless communications according to Bluetooth specification sets or another standard or proprietary wireless communication protocol. In another example, the network 130 may also include communications over a cellular network, including, for example, a GSM (Global System for Mobile Communications), CDMA (Code Division Multiple Access), or an EDGE (Enhanced Data for Global Evolution) network.

The system 100 illustrates an example of a system architecture and components that can be used to train and execute one or more AI models, such the AI model(s) 110c. Specifically, as depicted in FIG. 1A and described herein, the analytics server 110a can use the methods discussed herein to train the AI model(s) 110c using data retrieved from the egos 140 (e.g., by using data streams 172 and 174). When the AI model(s) 110c have been trained, each of the egos 140 may have access to and execute the trained AI model(s) 110c. For instance, the vehicle 140a having the ego computing device 141a may transmit its camera feed to the trained AI model(s) 110c and may generate a graph defining lane segments in the environment (e.g., data stream 174). Moreover, the data ingested and/or predicted by the AI model(s) 110c with respect to the egos 140 (at inference time) may also be used to improve the AI model(s) 110c. Therefore, the system 100 depicts a continuous loop that can periodically improve the accuracy of the AI model(s) 110c. Moreover, the system 100 depicts a loop in which data received the egos 140 can be used to at training phase in addition to the inference phase.

The analytics server 110a may be configured to collect, process, and analyze navigation data (e.g., images captured while navigating) and various sensor data collected from the egos 140. The collected data may then be processed and prepared into a training dataset. The training dataset may then be used to train one or more AI models, such as the AI model 110c. The analytics server 110a may also be configured to collect visual data from the egos 140. Using the AI model 110c (trained using the methods and systems discussed herein), the analytics server 110a may generate a dataset and/or an occupancy map for the egos 140. The analytics server 110a may display the occupancy map on the egos 140 and/or transmit the occupancy map/dataset to the ego computing devices 141, the administrator computing device 120, and/or the server 160.

In FIG. 1A, the AI model 110c is illustrated as a component of the system database 110b, but the AI model 110c may be stored in a different or a separate component, such as cloud storage or any other data repository accessible to the analytics server 110a.

The analytics server 110a may also be configured to display an electronic platform illustrating various training attributes for training the AI model 110c. The electronic platform may be displayed on the administrator computing device 120, such that an analyst can monitor the training of the AI model 110c. An example of the electronic platform generated and hosted by the analytics server 110a may be a web-based application or a website configured to display the training dataset collected from the egos 140 and/or training status/metrics of the AI model 110c.

The analytics server 110a may be any computing device comprising a processor and non-transitory machine-readable storage capable of executing the various tasks and processes described herein. Non-limiting examples of such computing devices may include workstation computers, laptop computers, server computers, and the like. While the system 100 includes a single analytics server 110a, the system 100 may include any number of computing devices operating in a distributed computing environment, such as a cloud environment.

The egos 140 may represent various electronic data sources that transmit data associated with their previous or current navigation sessions to the analytics server 110a. The egos 140 may be any apparatus configured for navigation, such as a vehicle 140a and/or a truck 140c. The egos 140 are not limited to being vehicles and may include robotic devices as well. For instance, the egos 140 may include a robot 140b, which may represent a general purpose, bipedal, autonomous humanoid robot capable of navigating various terrains. The robot 140b may be equipped with software that enables balance, navigation, perception, or interaction with the physical world. The robot 140b may also include various cameras configured to transmit visual data to the analytics server 110a.

Even though referred to herein as an “ego,” the egos 140 may or may not be autonomous devices configured for automatic navigation. For instance, in some embodiments, the ego 140 may be controlled by a human operator or by a remote processor. The ego 140 may include various sensors, such as the sensors depicted in FIG. 1B. The sensors may be configured to collect data as the egos 140 navigate various terrains (e.g., roads). The analytics server 110a may collect data provided by the egos 140. For instance, the analytics server 110a may obtain navigation session and/or road/terrain data (e.g., images of the egos 140 navigating roads) from various sensors, such that the collected data is eventually used by the AI model 110c for training purposes.

As used herein, a navigation session corresponds to a trip where egos 140 travel a route, regardless of whether the trip was autonomous or controlled by a human. In some embodiments, the navigation session may be for data collection and model training purposes. However, in some other embodiments, the egos 140 may refer to a vehicle purchased by a consumer and the purpose of the trip may be categorized as everyday use. The navigation session may start when the egos 140 move from a non-moving position beyond a threshold distance (e.g., 0.1 miles, 100 feet) or exceed a threshold speed (e.g., over 0 mph, over 1 mph, over 5 mph). The navigation session may end when the egos 140 are returned to a non-moving position and/or are turned off (e.g., when a driver exits a vehicle).

The egos 140 may represent a collection of egos monitored by the analytics server 110a to train the AI model(s) 110c. For instance, a driver for the vehicle 140a may authorize the analytics server 110a to monitor data associated with their respective vehicle. As a result, the analytics server 110a may utilize various methods discussed herein to collect sensor/camera data and generate a training dataset to train the AI model(s) 110c accordingly. The analytics server 110a may then apply the trained AI model(s) 110c to analyze data associated with the egos 140 and to predict an occupancy map for the egos 140. Moreover, additional/ongoing data associated with the egos 140 can also be processed and added to the training dataset, such that the analytics server 110a re-calibrates the AI model(s) 110c accordingly. Therefore, the system 100 depicts a loop in which navigation data received from the egos 140 can be used to train the AI model(s) 110c. The egos 140 may include processors that execute the trained AI model(s) 110c for navigational purposes. While navigating, the egos 140 can collect additional data regarding their navigation sessions, and the additional data can be used to calibrate the AI model(s) 110c. That is, the egos 140 represent egos that can be used to train, execute/use, and re-calibrate the AI model(s) 110c. In a non-limiting example, the egos 140 represent vehicles purchased by customers that can use the AI model(s) 110c to autonomously navigate while simultaneously improving the AI model(s) 110c.

The egos 140 may be equipped with various technology allowing the egos to collect data from their surroundings and (possibly) navigate autonomously. For instance, the egos 140 may be equipped with inference chips to run self-driving software.

Various sensors for each ego 140 may monitor and transmit the collected data associated with different navigation sessions to the analytics server 110a. FIGS. 1B-C illustrate block diagrams of sensors integrated within the egos 140, according to an embodiment. The number and position of each sensor discussed with respect to FIGS. 1B-C may depend on the type of ego discussed in FIG. 1A. For instance, the robot 140b may include different sensors than the vehicle 140a or the truck 140c. For instance, the robot 140b may not include the airbag activation sensor 170q. Moreover, the sensors of the vehicle 140a and the truck 140c may be positioned differently than illustrated in FIG. 1C.

As discussed herein, various sensors integrated within each ego 140 may be configured to measure various data associated with each navigation session. The analytics server 110a may periodically collect data monitored and collected by these sensors, wherein the data is processed in accordance with the methods described herein and used to train the AI model 110c and/or execute the AI model 110c to generate the occupancy map.

The egos 140 may include a user interface 170a. The user interface 170a may refer to a user interface of an ego computing device (e.g., the ego computing devices 141 in FIG. 1A). The user interface 170a may be implemented as a display screen integrated with or coupled to the interior of a vehicle, a heads-up display, a touchscreen, or the like. The user interface 170a may include an input device, such as a touchscreen, knobs, buttons, a keyboard, a mouse, a gesture sensor, a steering wheel, or the like. In various embodiments, the user interface 170a may be adapted to provide user input (e.g., as a type of signal and/or sensor information) to other devices or sensors of the egos 140 (e.g., sensors illustrated in FIG. 1B), such as a controller 170c.

The user interface 170a may also be implemented with one or more logic devices that may be adapted to execute instructions, such as software instructions, implementing any of the various processes and/or methods described herein. For example, the user interface 170a may be adapted to form communication links, transmit and/or receive communications (e.g., sensor signals, control signals, sensor information, user input, and/or other information), or perform various other processes and/or methods. In another example, the driver may use the user interface 170a to control the temperature of the egos 140 or activate its features (e.g., autonomous driving or steering system 1700). Therefore, the user interface 170a may monitor and collect driving session data in conjunction with other sensors described herein. The user interface 170a may also be configured to display various data generated/predicted by the analytics server 110a and/or the AI model 110c.

An orientation sensor 170b may be implemented as one or more of a compass, float, accelerometer, and/or other digital or analog device capable of measuring the orientation of the egos 140 (e.g., magnitude and direction of roll, pitch, and/or yaw, relative to one or more reference orientations such as gravity and/or magnetic north). The orientation sensor 170b may be adapted to provide heading measurements for the egos 140. In other embodiments, the orientation sensor 170b may be adapted to provide roll, pitch, and/or yaw rates for the egos 140 using a time series of orientation measurements. The orientation sensor 170b may be positioned and/or adapted to make orientation measurements in relation to a particular coordinate frame of the egos 140.

A controller 170c may be implemented as any appropriate logic device (e.g., processing device, microcontroller, processor, application-specific integrated circuit (ASIC), field programmable gate array (FPGA), memory storage device, memory reader, or other device or combinations of devices) that may be adapted to execute, store, and/or receive appropriate instructions, such as software instructions implementing a control loop for controlling various operations of the egos 140. Such software instructions may also implement methods for processing sensor signals, determining sensor information, providing user feedback (e.g., through user interface 170a), querying devices for operational parameters, selecting operational parameters for devices, or performing any of the various operations described herein.

A communication module 170e may be implemented as any wired and/or wireless interface configured to communicate sensor data, configuration data, parameters, and/or other data and/or signals to any feature shown in FIG. 1A (e.g., analytics server 110a). As described herein, in some embodiments, communication module 170e may be implemented in a distributed manner such that portions of communication module 170e are implemented within one or more elements and sensors shown in FIG. 1B. In some embodiments, the communication module 170e may delay communicating sensor data. For instance, when the egos 140 do not have network connectivity, the communication module 170e may store sensor data within temporary data storage and transmit the sensor data when the egos 140 are identified as having proper network connectivity.

A speed sensor 170d may be implemented as an electronic pitot tube, metered gear or wheel, water speed sensor, wind speed sensor, wind velocity sensor (e.g., direction and magnitude), and/or other devices capable of measuring or determining a linear speed of the egos 140 (e.g., in a surrounding medium and/or aligned with a longitudinal axis of the egos 140) and providing such measurements as sensor signals that may be communicated to various devices.

A gyroscope/accelerometer 170f may be implemented as one or more electronic sextants, semiconductor devices, integrated chips, accelerometer sensors, or other systems or devices capable of measuring angular velocities/accelerations and/or linear accelerations (e.g., direction and magnitude) of the egos 140, and providing such measurements as sensor signals that may be communicated to other devices, such as the analytics server 110a. The gyroscope/accelerometer 170f may be positioned and/or adapted to make such measurements in relation to a particular coordinate frame of the egos 140. In various embodiments, the gyroscope/accelerometer 170f may be implemented in a common housing and/or module with other elements depicted in FIG. 1B to ensure a common reference frame or a known transformation between reference frames.

A global navigation satellite system (GNSS) 170h may be implemented as a global positioning satellite receiver and/or another device capable of determining absolute and/or relative positions of the egos 140 based on wireless signals received from space-born and/or terrestrial sources, for example, and capable of providing such measurements as sensor signals that may be communicated to various devices. In some embodiments, the GNSS 170h may be adapted to determine the velocity, speed, and/or yaw rate of the egos 140 (e.g., using a time series of position measurements), such as an absolute velocity and/or a yaw component of an angular velocity of the egos 140.

A temperature sensor 170i may be implemented as a thermistor, electrical sensor, electrical thermometer, and/or other devices capable of measuring temperatures associated with the egos 140 and providing such measurements as sensor signals. The temperature sensor 170i may be configured to measure an environmental temperature associated with the egos 140, such as a cockpit or dash temperature, for example, which may be used to estimate a temperature of one or more elements of the egos 140.

A humidity sensor 170j may be implemented as a relative humidity sensor, electrical sensor, electrical relative humidity sensor, and/or another device capable of measuring a relative humidity associated with the egos 140 and providing such measurements as sensor signals.

A steering sensor 170g may be adapted to physically adjust a heading of the egos 140 according to one or more control signals and/or user inputs provided by a logic device, such as controller 170c. Steering sensor 170g may include one or more actuators and control surfaces (e.g., a rudder or other type of steering or trim mechanism) of the egos 140 and may be adapted to physically adjust the control surfaces to a variety of positive and/or negative steering angles/positions. The steering sensor 170g may also be adapted to sense a current steering angle/position of such steering mechanism and provide such measurements.

A propulsion system 170k may be implemented as a propeller, turbine, or other thrust-based propulsion system, a mechanical wheeled and/or tracked propulsion system, a wind/sail-based propulsion system, and/or other types of propulsion systems that can be used to provide motive force to the egos 140. The propulsion system 170k may also monitor the direction of the motive force and/or thrust of the egos 140 relative to a coordinate frame of reference of the egos 140. In some embodiments, the propulsion system 170k may be coupled to and/or integrated with the steering sensor 170g.

An occupant restraint sensor 170l may monitor seatbelt detection and locking/unlocking assemblies, as well as other passenger restraint subsystems. The occupant restraint sensor 170l may include various environmental and/or status sensors, actuators, and/or other devices facilitating the operation of safety mechanisms associated with the operation of the egos 140. For example, occupant restraint sensor 170l may be configured to receive motion and/or status data from other sensors depicted in FIG. 1B. The occupant restraint sensor 170l may determine whether safety measurements (e.g., seatbelts) are being used.

Cameras 170m may refer to one or more cameras integrated within the egos 140 and may include multiple cameras integrated (or retrofitted) into the ego 140, as depicted in FIG. 1C. The cameras 170m may be interior-or exterior-facing cameras of the egos 140. For instance, as depicted in FIG. 1C, the egos 140 may include one or more interior-facing cameras that may monitor and collect footage of the occupants of the egos 140. The egos 140 may include eight exterior facing cameras. For example, the egos 140 may include a front camera 170m-1, a forward-looking side camera 170m-2, a forward-looking side camera 170m-3, a rearward looking side camera 170m-4 on each front fender, a camera 170m-5 (e.g., integrated within a B-pillar) on each side, and a rear camera 170m-6.

Referring to FIG. 1B, a radar 170n and ultrasound sensors 170p may be configured to monitor the distance of the egos 140 to other objects, such as other vehicles or immobile objects (e.g., trees or garage doors). The egos 140 may also include an autonomous driving or steering system 170o configured to use data collected via various sensors (e.g., radar 170n, speed sensor 170d, and/or ultrasound sensors 170p) to autonomously navigate the ego 140.

Therefore, autonomous driving or steering system 1700 may analyze various data collected by one or more sensors described herein to identify driving data. For instance, autonomous driving or steering system 1700 may calculate a risk of forward collision based on the speed of the ego 140 and its distance to another vehicle on the road. The autonomous driving or steering system 1700 may also determine whether the driver is touching the steering wheel. The autonomous driving or steering system 1700 may transmit the analyzed data to various features discussed herein, such as the analytics server.

An airbag activation sensor 170q may anticipate or detect a collision and cause the activation or deployment of one or more airbags. The airbag activation sensor 170q may transmit data regarding the deployment of an airbag, including data associated with the event causing the deployment.

Referring back to FIG. 1A, the administrator computing device 120 may represent a computing device operated by a system administrator. The administrator computing device 120 may be configured to display data retrieved or generated by the analytics server 110a (e.g., various analytic metrics and risk scores), wherein the system administrator can monitor various models utilized by the analytics server 110a, review feedback, and/or facilitate the training of the AI model(s) 110c maintained by the analytics server 110a.

The ego(s) 140 may be any device configured to navigate various routes, such as the vehicle 140a or the robot 140b. As discussed with respect to FIGS. 1B-C, the ego 140 may include various telemetry sensors. The egos 140 may also include ego computing devices 141. Specifically, each ego may have its own ego computing device 141. For instance, the truck 140c may have the ego computing device 141c. For brevity, the ego computing devices are collectively referred to as the ego computing device(s) 141. The ego computing devices 141 may control the presentation of content on an infotainment system of the egos 140, process commands associated with the infotainment system, aggregate sensor data, manage communication of data to an electronic data source, receive updates, and/or transmit messages. In one configuration, the ego computing device 141 communicates with an electronic control unit. In another configuration, the ego computing device 141 is an electronic control unit. The ego computing devices 141 may comprise a processor and a non-transitory machine-readable storage medium capable of performing the various tasks and processes described herein. For example, the AI model(s) 110c described herein may be stored and performed (or directly accessed) by the ego computing devices 141. Non-limiting examples of the ego computing devices 141 may include a vehicle multimedia and/or display system.

In one example of training AI models 110c, the analytics servers 110a can collect data from egos 140 to train the AI model(s) 110c. Before executing the AI model(s) 110c to generate or predict a graph defining lane segments, the analytics server 110a may train the AI model(s) 110c using various methods. The training allows the AI model(s) 110c to ingest data from one or more cameras of one or more egos 140 (without the need to receive radar data) and predict occupancy data for the ego's surroundings. The operation described in this example may be executed by any number of computing devices operating in the distributed computing system described in FIGS. 1A and 1B (e.g., a processor of the egos 140).

To train the AI model(s) 110c, the analytics server 110a may first employ one or more of the egos 140 to drive a particular route. While driving, the egos 140 may use one or more of their sensors (including one or more cameras) to generate navigation session data. For instance, the one or more of the egos 140 equipped with various sensors can navigate the designated route. As the one or more of the egos 140 traverse the terrain, their sensors may capture continuous (or periodic) data of their surroundings. The sensors may indicate an occupancy status of the one or more egos' 140 surroundings. For instance, the sensor data may indicate various objects having mass in the surroundings of the one or more of the egos 140 as they navigate their route.

In operation, as the one or more egos 140 navigate, their sensors collect data and transmit the data to the analytics server 110a, as depicted in the data stream 172. In some embodiments, the one or more egos 140 may include one or more high-resolution cameras that capture a continuous stream of visual data from the surroundings of the one or more egos 140 as the one or more egos 140 navigate through the route. The analytics server 110a may then generate a second dataset using the camera feed where visual elements/depictions of different voxels of the one or more egos' 140 surroundings are included within the second dataset. In operation, as the one or more egos 140 navigate, their cameras collect data and transmit the data to the analytics server 110a, as depicted in the data stream 172. For instance, the ego computing devices 141 may transmit image data to the analytics server 110a using the data stream 172.

The analytics server 110a may generate a training dataset using data collected from the egos 140 (e.g., camera feed received from the egos 140). The training dataset can identify or include a set of examples. Each example can identify or include input data and expected output data from the input data. In each example, the input can include the collected data, such as sensor data (e.g., video or image from one or more cameras) and map data (e.g., navigation map) from egos 140. The output can include environment features (e.g., attributes gathered from the sensor data), map features (e.g., attributes in navigation map such as topological features and road layouts), classifications (e.g., a type of topology), and an output token (e.g., a combination of environment features, map features, and classifications) to be included in a graph defining lane segments, among others. In some embodiments, the output can be created by a human reviewer examining the input data.

Using the training dataset, the analytics server 110a may feed the series of training datasets to the AI model(s) 110c and obtain a set of predicted outputs (e.g., environment features, map features, classifications, and output tokens). The analytics server 110a may then compare the predicted data with the ground truth data to determine a difference and train the AI model(s) 110c by adjusting the AI model's 110c internal weights and parameters proportional to the determined difference according to a loss function. The analytics server 110a may train the AI model(s) 110c in a similar manner until the trained AI model's 110c prediction is accurate to a certain threshold (e.g., recall or precision).

In some embodiments, the analytics server 110a may use a supervised method of training. For instance, using the ground truth and the visual data received, the AI model(s) 110c may train itself, such that it can predict an output. As a result, when trained, the AI model(s) 110c may receive sensor data and map data, analyze the received data, and generate the token. In some embodiments, the analytics server 110a may use an unsupervised method where the training dataset is not labeled. Because labeling the data within the training dataset may be time-consuming and may require excessive computing power, the analytics server 110a may utilize unsupervised training techniques to train the AI model 110c.

With the establishment of the AI model 110c, the analytics server 110a can transmit, send, or otherwise distribute the weights of the AI model 110c to each of the ego computing devices 141a-c. Upon receipt, the ego computing device 141a-c can store and maintain the AI model 110c on a local storage. Once stored and loaded, the ego computing device 141a-c can use in processing newly acquired data (e.g., sensor and map data) to create graphs to define lane segments to autonomously navigate the respective ego 140a-c through the environment. From time to time, the analytics server 110a can transmit, send, or otherwise distribute the updated weights of the AI model 110c to update instances of the AI model 110c on the ego computing devices 141a-c.

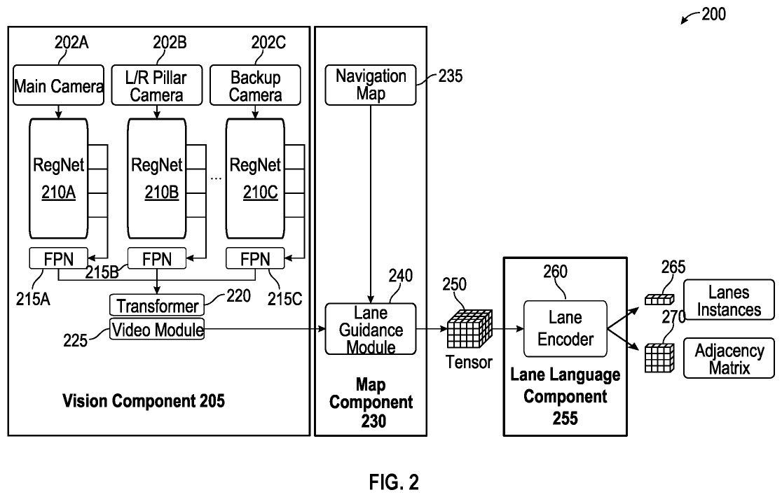

Referring now to FIG. 2, depicted is a block diagram for an architecture of a system 200 for generating tensor representations of pathways for autonomously navigating through an environment. The system 200 can be implemented using any of the components described herein, such as the ego computing devices 141a-c and the AI model(s) 110c. The system 200 may include components and steps as described herein. However, other embodiments may include additional or alternative components and steps or may omit one or more components and steps. The system 200 and its architecture can be implemented by an analytics server (e.g., a computer similar to the analytics server 110a) or by an ego computing device (e.g., ego computing devices 141a-c), or across the multiple computing systems. However, one or more steps of the system 200 may be implemented by any number of computing devices operating in the distributed computing system described in FIGS. 1A-C (e.g., a processor of the ego 140 and/or ego computing devices 141). For instance, one or more computing devices of an ego may locally implement some or all components and steps described in FIG. 2.

The system 200 can include at least one visual component 205 to process sensor data. The visual component 205 can include a set of cameras, such as at least one main camera 202A, at least one left or right pillar camera 202B, and at least one backup camera 202C, among others. The set of cameras 202A-C (generally herein referred to as cameras 202) can be instances of the cameras 170m and can be multiple cameras integrated (or retrofitted) into the ego 140 as discussed herein. Each camera 202 can acquire and collect images (e.g., optical vision images) of the environment surrounding the ego. The images can be in the form of a set of frames for video acquired by the cameras 202. In some embodiments, the visual component 205 can include other sensors such as radar 170n and ultrasound sensors 170p, as discussed herein. In some embodiments, the visual component 205 may rely on solely optical images captured through optical cameras 202.

The visual component 205 can include artificial intelligence (AI) algorithms or machine learning (ML) models to process the sensor data from the set of cameras and other sensors. The ML models can be trained and established as discussed herein. In general, the ML models of the visual component 205 can generate a set of embeddings corresponding to a reduced dimension representation of the sensor data. The ML models in the visual component 205 can include, for example, a set of self-regulated networks (RegNets) 210A-C (hereinafter generally referred to as residual networks 210), a set of feature pyramid networks (FPNs) 215A-C (hereinafter generally referred to as feature pyramid networks 215), at least one transformer 220, and at least one video module 225, among others.

Each self-regulated network 210 can include a set of weights arranged in accordance with a set of convolutional recurrent neural networks (RNNs) (e.g., including a set of long short-term memory networks (LSTMs) or gated recurrent units (GRNs)) with operators (e.g., concatenators and activation functions), among others. Each self-regulated network 210 can retrieve, identify, or otherwise receive the sensor data from a corresponding camera 202 (or other sensor). Upon receipt, the self-regulated network 210 can process the sensor data in accordance with the set of weights to generate a set of embeddings (e.g., a feature map). The set of embeddings can be a reduced dimensional representation of sensor data, in particular with spatio-temporal features. The self-regulated network 210 can feed the output set of embeddings forwards to a respective feature pyramid network 215.

Each feature pyramid networks 215 can include a set of weights arranged in accordance with a set of convolutional neural networks (CNNs) at multiple scales to detect features within input data. Each feature pyramid networks 215 can retrieve, identify, or otherwise receive the output set of embeddings from a corresponding self-regulated network 210. With receipt, the feature pyramid networks 215 can process the set of embeddings from the self-regulated network 210 using the set of weights to generate another set of embeddings. The set of embeddings can be a further reduced dimensional representation of sensor data. In addition, the transformer 220 can include a set of weights arranged in accordance with a transformer architecture with multi-head attention mechanisms. The feature pyramid network 215 can feed the output set of embeddings forwards to the transformer 220.

The transformer 220 can receive, collect, or otherwise aggregate the set of embeddings generated by the feature pyramid networks 215 and by extension the self-regulated networks 210 from the sensor data. The transformer 220 can process the set of embeddings in accordance with the set of weights to generate another set of embeddings (or output tokens). The video module 225 can receive, collect, or otherwise aggregate the set of embeddings outputted by the transformer 220. Upon receipt, the video module 225 can combine the set of embeddings corresponding to sensor data acquired over a defined period of time. With the combination, the video module 225 can generate an aggregated set of embeddings to feed forward. The resultant set of embeddings can represent or define a reduced dimensional representation of sensor data acquired via the cameras 202 (or other sensors).

The system 200 can include at least one map component 230 to process map data, such as a navigation map 235. The navigation map 235 can include or identify data defining a map or topology of an environment surrounding the ego, such as a type of terrain, elevation, or a semantic label of roads (e.g., navigable routes, unpaved paths, street, avenue, highway, bus lane, lane count, and ramps) or other features (e.g., geometries, buildings, signage, and flora) by coordinates (e.g., geographic positioning system (GPS) coordinates) in the environment, among others. The map component 230 can retrieve, obtain, or otherwise acquire the navigation map 235 relative to the position of the ego in the environment. For example, the map component 230 can acquire a navigation map 235 of a defined size (e.g., 2 km by 2 km) along a direction of travel of the ego.

The map component 230 can include at least one lane guidance module 240 to enhance the set of embeddings from the vision component 205 with a set of embeddings derived from the navigation map 235. The lane guidance module 240 can set of weights arranged in accordance with an encoder (e.g., set of convolutional neural networks (CNNs)), among others. The lane guidance module 240 can retrieve, obtain, or otherwise identify the navigation map 235 defining the topology surrounding the ego. With the identification, the lane guidance module 240 can process the data of the navigation map 235 using the set of weights to generate a set of embeddings. The set of embeddings can be a lower dimensional representation of pertinent features in the navigation map 235. In some embodiments, the lane guidance module 240 can process the data from the navigation map 235 with the set of embeddings from the lane component 205. The lane guidance module 240 can combine the set of embeddings derived from the sensor data with the set of embeddings derived from the navigation map 235 to produce, output, or otherwise generate at least one tensor 250. The tensor 250 can include the aggregate set of embeddings derived from both the sensor data and the map data.

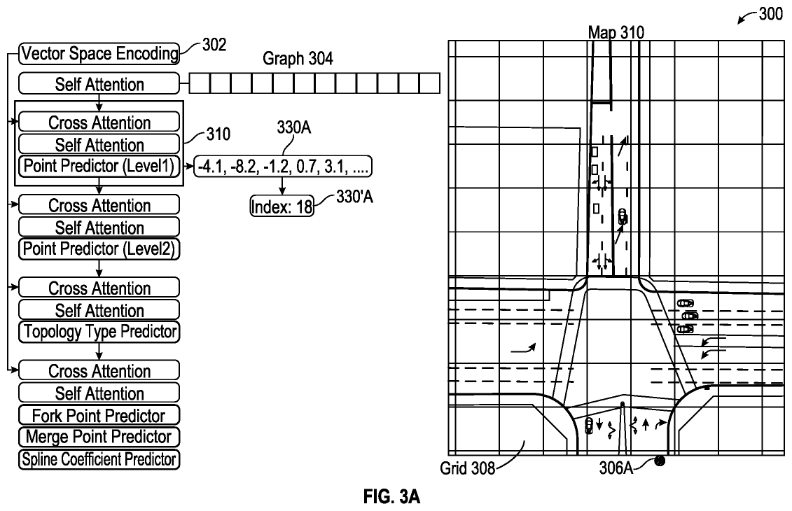

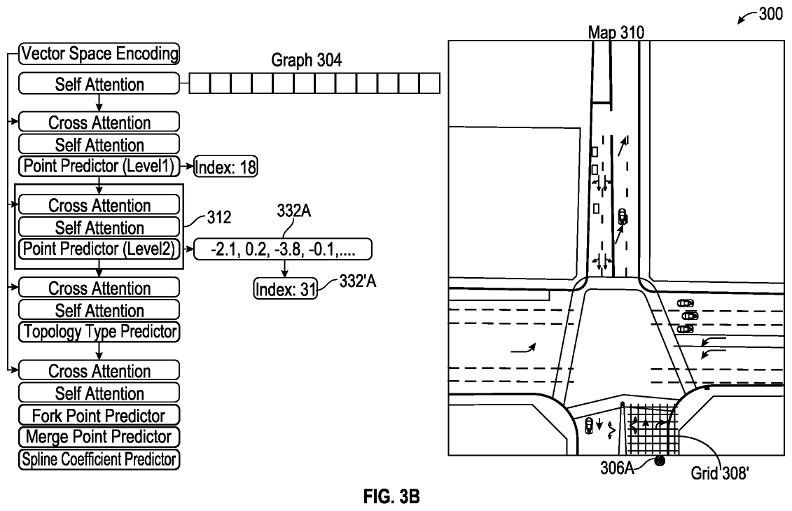

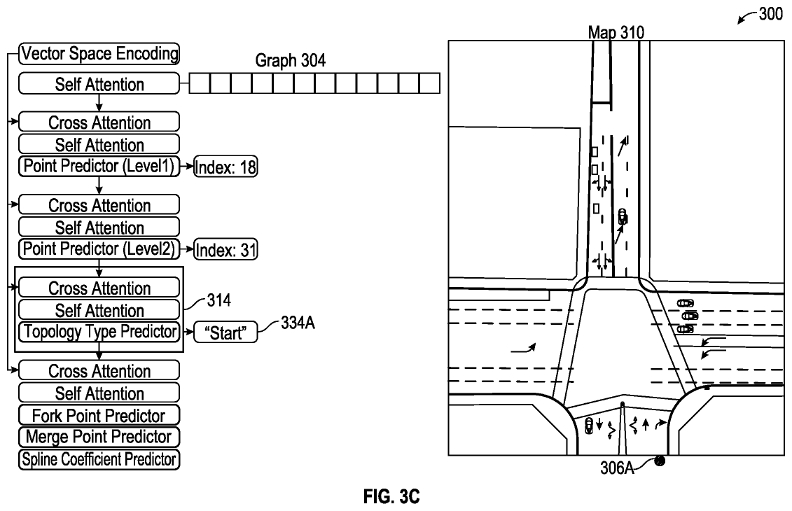

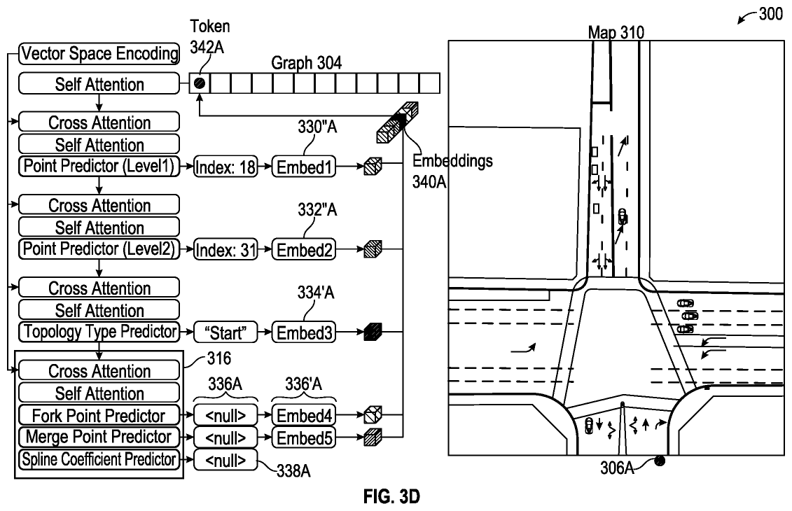

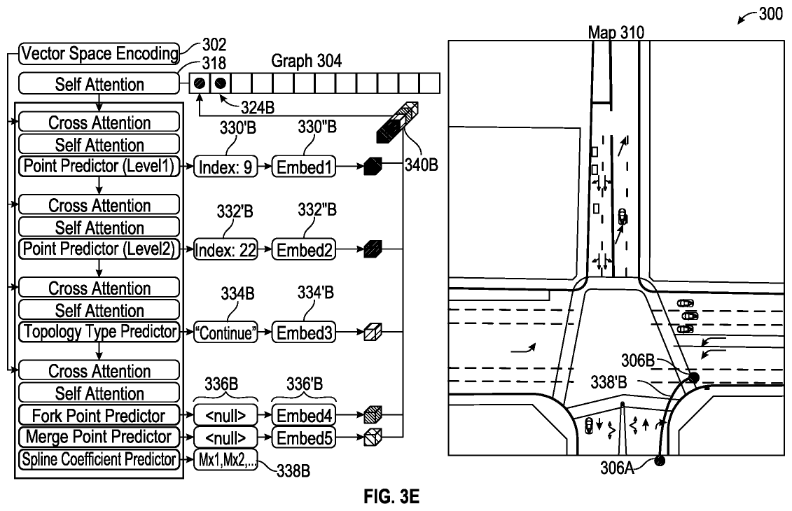

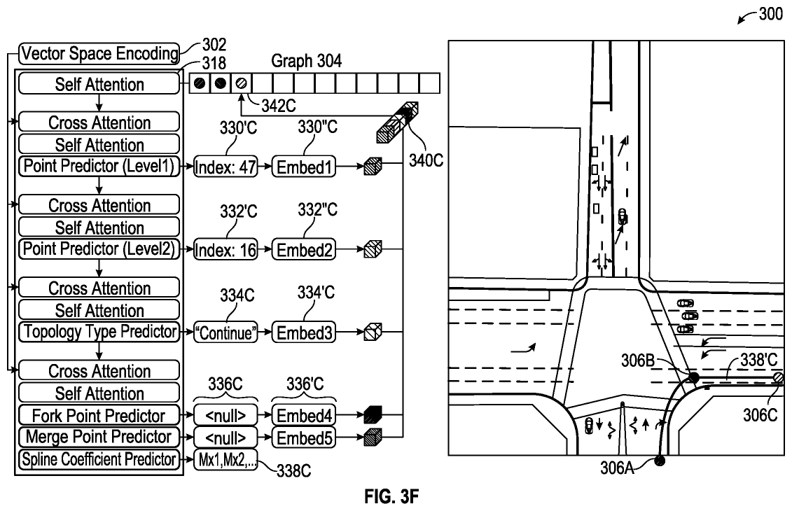

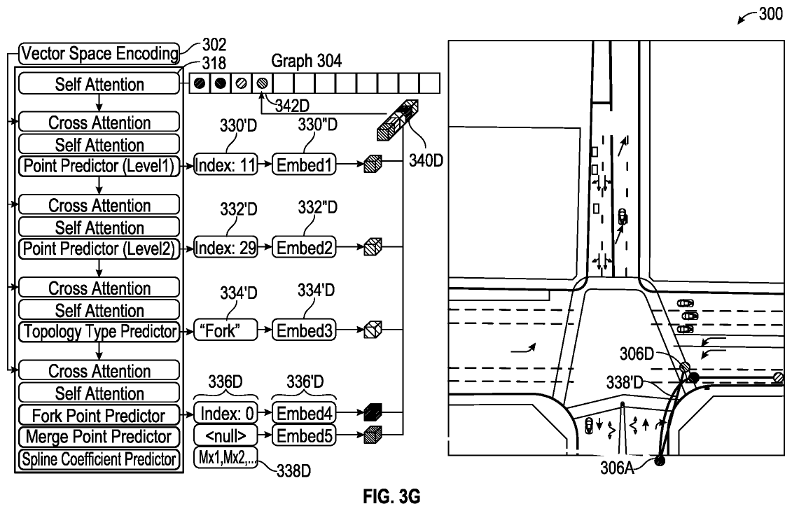

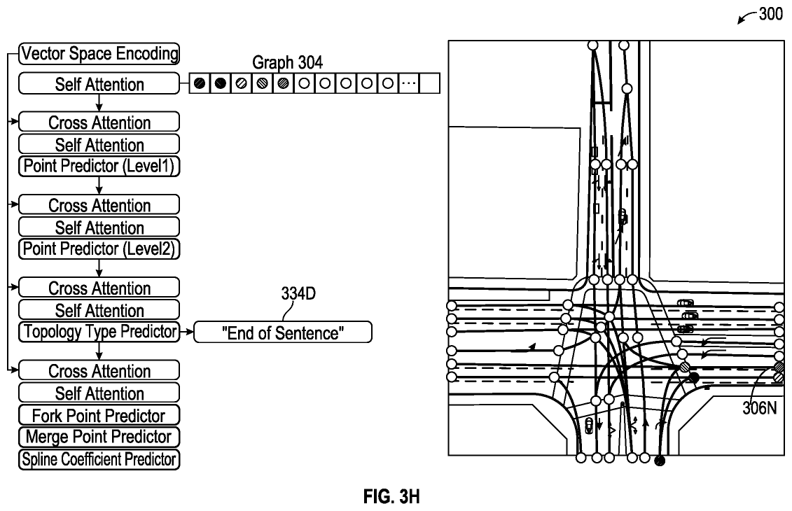

The system 200 can include at least one lane language component 255 to process the tensor 250 from the map component 230. The lane language component 255 can include at least one lane encoder 260. The lane encoder 260 can include a set of weights arranged in accordance with an encoder or decoder, such as an autoregressive decoder, among others. The autoregressive decoder of the lane encoder 260 can include a sequence of models to process portions of input embeddings from the tensor 250 to generate output embeddings dependent on another output embedding derived from prior portion of input embeddings. From processing the tensor 250, the lane encoder 260 can produce, output, or otherwise generate a set of lane instances 265 and at least one adjacency matrix 270. The lane instances 265 can define one or more lane segments through which the ego can potentially navigate the environment. The adjacent matrix 270 can define a connectivity or relationship among the lane segments defined in the lane segments 265. The lane instances 265 and the adjacency matrix 270 can collectively be referred to as a graph or a language of lanes. Additional details regarding the details regarding the functioning of the lane language component 255 and the lane encoder 260 are provided herein in conjunction with FIGS. 3A-H.

Referring now to FIG. 3A-H, depicted are block diagrams of a process 300 of generating pathways for autonomously navigating through an environment. The process 300 can be implemented using any of the components described herein, such as the ego computing devices 141a-c and the AI model(s) 110c. The process 300 may include steps as described herein. However, other embodiments may include additional or alternative steps or may omit one or more steps. The process 300 may be executed by an analytics server (e.g., a computer similar to the analytics server 110a) or by an ego computing device (e.g., ego computing devices 141a-c). However, one or more steps of the process 300 may be executed by any number of computing devices operating in the distributed computing system described in FIGS. 1A-C (e.g., a processor of the ego 140 and/or ego computing devices 141 or centralized service such as the analytics server 110a). For instance, one or more computing devices of an ego may locally perform some or all steps described in FIGS. 3A-H.

Starting from FIG. 3A, under the process 300, a computing system can retrieve, receive, or otherwise identify at least one vector space encoding 302 (e.g., the tensor 250) to be used to form or generate at least one graph 304. The computing system executing the process 300 may correspond to the ego computing device 141 on an ego 140 or a centralized service such as the analytics server 110a. The vector space encoding 302 (sometimes herein referred to as a tensor) can identify or include a set of encodings (sometimes herein referred as a set of embeddings or feature maps). The set of encodings of the vector space encoding 302 can be generated, determined, or otherwise derived from sensor data (e.g., from cameras and other sensors) acquired by an ego and map data (e.g., the navigation map 235) defining a topology of an environment surrounding the ego. The encodings can be lower dimensional representations of latent features derived from the sensor data and the map data. The graph 304 can be used to define a set of pathways (sometimes herein referred to as lane segments) along which the ego can autonomously navigate through the environment.

With the identification, the computing system can find, determine, or otherwise identify at least one point 306A within a set of grid points in a first grid 308 defined over the environment represented by a map 310. The point 306A can correspond to a starting point from which the ego is to navigate through the environment as defined by the map 310. The grid 308 can specify or define the set of grid points (or coordinates) at a resolution coarser or lower than an original resolution of the grid point as defined by the map 310. The map 310 can correspond to a layout of the topology surrounding the ego and can be acquired as part of the map data (e.g., navigation map 235).

The computing system can input, feed, or otherwise apply at least a portion of the vector space encoding 302 to a first point predictor unit 310. The portion of the vector space encoding 302 inputted into the first point predictor unit 310 can correspond to the point 306A defined within the set of grid points in the first grid 308 in the environment. In some embodiments, the computing system can identify or select the portion of the vector space encoding 302 to input based on the point 306A. The first point predictor unit 310 can correspond to a portion of a machine learning (ML) model (e.g., the lane encoder 260 as discussed herein), and can include a set of weights arranged in accordance with a cross-attention, a self-attention, and a transformer, among others. In feeding, the computing system can process the portion of the vector space encoding 302 in accordance with the weights of the first point predictor unit 310 to calculate, determine, or otherwise generate at least one coordinate 330A corresponding to the point 306A. Using the point, the computing system can use the first point predictor unit 310 to calculate, produce, or otherwise determine a first index value 330′A for the point 306A.

Moving onto FIG. 3B, the computing system can find, determine, or otherwise identify at least one point 306A within a set of grid points in a second grid 308′ defined over the environment represented by a map 312. The computing system may correspond to the ego computing device 141 on an ego 140 or a centralized service such as the analytics server 110a. The point 306A can correspond to the starting point from which the ego is to navigate through the environment as defined by the map 312. The second grid 308′ can specify or define the set of grid points (or coordinates) at the resolution finer or higher than the resolution of the first grid 308. The second grid 308′ can correspond to a subset of the first grid 308 surrounding or about the ego. The map 312 can correspond to a layout of the topology surrounding the ego and can be acquired as part of the map data (e.g., navigation map 235).

The computing system can input, feed, or otherwise apply at least a portion of the vector space encoding 302 and an output (e.g., embeddings derived from the first index value 330′A) of the first point predictor unit 310 to a second point predictor unit 312. The portion of the vector space encoding 302 can correspond to the point 306A defined within the set of grid points in the first grid 308′ in the environment. The portion of the vector space encoding 302 inputted into the second point prediction unit 312 can be the same or can differ from the portion of the vector space encoding 302 inputted into the first point prediction unit 310. In some embodiments, the computing system can identify or select the portion of the vector space encoding 302 to input based on the point 306A.

The second point predictor unit 312 can correspond to a portion of a machine learning (ML) model (e.g., the lane encoder 260 as discussed herein), and can include a set of weights arranged in accordance with a cross-attention, a self-attention, and a transformer, among others. In feeding, the computing system can process the portion of the vector space encoding 302 in accordance with the weights of the second point predictor unit 312 to calculate, determine, or otherwise generate at least one coordinate 332A corresponding to the point 306A. Using the point, the computing system can use the second point predictor unit 312 to calculate, produce, or otherwise determine a first index value 332′A for the point 306A.

Continuing onto FIG. 3C, the computing system can input, feed, or otherwise apply at least a portion of the vector space encoding 302 to a topology predictor unit 314. The computing system may correspond to the ego computing device 141 on an ego 140 or a centralized service such as the analytics server 110a. In addition, the computing system can apply an output (e.g., embeddings derived from the first index value 330′A) of the first point predictor unit 310 or an output (e.g., embeddings derived from the second index value 332′A) of the second point predictor unit 312 into the topology predictor unit 314. The portion of the vector space encoding 302 inputted into the topology predictor unit 314 can be the same or can differ from the portion of the vector space encoding 302 inputted into the first point prediction unit 310 or the second point prediction unit 312. The topology predictor unit 314 can correspond to a portion of a machine learning (ML) model (e.g., the lane encoder 260 as discussed herein), and can include a set of weights arranged in accordance with a cross-attention, a self-attention, and a transformer, among others.

By applying the topology predictor unit 314, the computing system can determine, category, or otherwise classify the point 306A as at least one topology type 334A. The topology type 334A can semantically specify, identify, or otherwise define a function of the point 306A with respect to a pathway along which the ego navigating through the environment as represented by the map 310. The topology type can include, for example, a start type, a continuation type, a fork type, or a terminal type, among others. In the depicted example, the topology type 334A can be a start type to indicate a start of at least one of the pathways.

Next onto FIG. 3D, the computing system can input, feed, or otherwise apply at least a portion of the vector space encoding 302 to a point attribute predictor 316. The computing system may correspond to the ego computing device 141 on an ego 140 or a centralized service such as the analytics server 110a. In addition, the computing system can apply an output (e.g., embeddings derived from the first index value 330′A) of the first point predictor unit 310, an output (e.g., embeddings derived from the second index value 332′A) of the second point predictor unit 312, or an output (e.g., embeddings derived from the topology type 334′A) into the point attribute predictor 316. The portion of the vector space encoding 302 inputted into the point attribute predictor 316 can be the same or can differ from the portion of the vector space encoding 302 inputted into the first point prediction unit 310, the second point prediction unit 312, or the topology predictor unit 314.

The point attribute predictor 316 can correspond to a portion of a machine learning (ML) model (e.g., the lane encoder 260 as discussed herein), and can include a set of weights arranged in accordance with a cross-attention, a self-attention, and a transformer, among others. By applying the point attribute predictor 316, the computing system can generate or determine a set of point attributes 336A for the point 306A. The set of point attributes 336A can identify or include, for example: at least one fork point identifying an index value of a previous point from which the current point 306A forms a fork; at least one merge point identifying an index value of a previous point from which the current point 306A forms a merge; and a set of spline coefficients 338A, among others. In the depicted example, since the current point 306A is a starting point, there are no other points, and hence the set of point attributes 336A may be null.

With the generation outputs, the computing system can use the predictors in the ML model to generate individual embeddings to form or output a set of embeddings 340A for the point 306A. Using the first point predictor 310, the computing system can determine or generate at least one corresponding embedding 330″A from the first index value 330′A. Using the second point predictor 312, the computing system can determine or generate at least one corresponding embedding 332″A from the second index value 332′A. Using the second point predictor 312, the computing system can determine or generate at least one corresponding embedding 332″A from the second index value 332′A. Using the topology type predictor 314, the computing system can determine or generate at least one corresponding embedding 334′A from the topology type 334A. Likewise, using the point attribute predictor 316, the computing system can determine or generate a set of embeddings 336′A. The set of embeddings 336′A can lack spline coefficients.

Upon the generation of the individual embeddings (e.g., the embeddings 330″A, 332″A, 334′A, and 336′A), the computing system can write, produce, or otherwise generate the set of embeddings 340A. Based on the set of embeddings 340A, the computing system can produce, output, or otherwise generate at least one token 342A for at least one of the pathways through the environment. In some embodiments, the computing system can generate the token 342A based on the first index value 330A, the second index value 332A, the topology type 334A, or the set of point attributes 336A, or any combination thereof. With the generation, the computing system can add, insert, or otherwise include the token 342A in the graph 304. The computing system can store and maintain the graph 304 including the token 342A to be used autonomously navigate the ego through the environment via the pathways. The graph 304 can be maintained as one or more data structures (e.g., array, linked list, matrix, tree, hash, heap, table, or graph) on a data storage.

Referring now to FIG. 3E, the computing system can repeat a portion of the functionalities as described herein for a second point 306B. The computing system may correspond to the ego computing device 141 on an ego 140 or a centralized service such as the analytics server 110a. With the identification of the second point 306B, the computing system can find, determine, or otherwise identify at least one point 306B within a set of grid points in a first grid 308 defined over the environment represented by a map 310. The point 306B can correspond to an intermediate point which the ego is to traverse through while navigating through the environment as defined by the map 310. The grid 308 can specify or define the set of grid points (or coordinates) at a resolution coarser or lower than an original resolution of the grid point as defined by the map 310. The map 310 can correspond to a layout of the topology surrounding the ego and can be acquired as part of the map data (e.g., navigation map 235).

The computing system can input, feed, or otherwise apply at least a portion of the vector space encoding 302 to a first point predictor unit 310. The portion of the vector space encoding 302 inputted into the first point predictor unit 310 can correspond to the point 306B defined within the set of grid points in the first grid 308 in the environment. In some embodiments, the computing system can identify or select the portion of the vector space encoding 302 to input based on the point 306B. In feeding, the computing system can process the portion of the vector space encoding 302 in accordance with the weights of the first point predictor unit 310 to calculate, determine, or otherwise generate at least one coordinate 330B corresponding to the point 306B. Using the point, the computing system can use the first point predictor unit 310 to calculate, produce, or otherwise determine a first index value 330′B for the point 306B.

The computing system can find, determine, or otherwise identify at least one point 306B within a set of grid points in a second grid 308′ defined over the environment represented by a map 312. The point 306B can correspond to the starting point from which the ego is to navigate through the environment as defined by the map 312. The second grid 308′ can specify or define the set of grid points (or coordinates) at the resolution finer or higher than the resolution of the first grid 308. The second grid 308′ can correspond to a subset of the first grid 308 surrounding or about the ego. The map 312 can correspond to a layout of the topology surrounding the ego and can be acquired as part of the map data (e.g., navigation map 235).

The computing system can input, feed, or otherwise apply at least a portion of the vector space encoding 302 and an output (e.g., embeddings derived from the first index value 330′B) of the first point predictor unit 310 to a second point predictor unit 312. The portion of the vector space encoding 302 can correspond to the point 306B defined within the set of grid points in the first grid 308′ in the environment. The portion of the vector space encoding 302 inputted into the second point prediction unit 312 can be the same or can differ from the portion of the vector space encoding 302 inputted into the first point prediction unit 310. In some embodiments, the computing system can identify or select the portion of the vector space encoding 302 to input based on the point 306B. In feeding, the computing system can process the portion of the vector space encoding 302 in accordance with the weights of the second point predictor unit 312 to calculate, determine, or otherwise generate at least one coordinate 332B corresponding to the point 306B. Using the point, the computing system can use the second point predictor unit 312 to calculate, produce, or otherwise determine a first index value 332′B for the point 306B.

The computing system can input, feed, or otherwise apply at least a portion of the vector space encoding 302 to the topology predictor unit 314. In addition, the computing system can apply an output (e.g., embeddings derived from the first index value 330′B) of the first point predictor unit 310 or an output (e.g., embeddings derived from the second index value 332′B) of the second point predictor unit 312 into the topology predictor unit 314. The portion of the vector space encoding 302 inputted into the topology predictor unit 314 can be the same or can differ from the portion of the vector space encoding 302 inputted into the first point prediction unit 310 or the second point prediction unit 312.

By applying the topology predictor unit 314, the computing system can determine, category, or otherwise classify the point 306B as at least one topology type 334B. The topology type 334B can semantically specify, identify, or otherwise define a function of the point 306B with respect to a pathway along which the ego navigating through the environment as represented by the map 310. The topology type can include, for example, a start type, a continuation type, a fork type, or a terminal type, among others. In the depicted example, the topology type 334B can be a continuation type to indicate a continuation of at least one of the pathways between the point 306A and the point 306B.

The computing system can input, feed, or otherwise apply at least a portion of the vector space encoding 302 to a point attribute predictor 316. In addition, the computing system can apply an output (e.g., embeddings derived from the first index value 330′B) of the first point predictor unit 310, an output (e.g., embeddings derived from the second index value 332′B) of the second point predictor unit 312, or an output (e.g., embeddings derived from the topology type 334′B) into the point attribute predictor 316. The portion of the vector space encoding 302 inputted into the point attribute predictor 316 can be the same or can differ from the portion of the vector space encoding 302 inputted into the first point prediction unit 310, the second point prediction unit 312, or the topology predictor unit 314.

By applying the point attribute predictor 316, the computing system can generate or determine a set of point attributes 336B for the point 306B. The set of point attributes 336B can identify or include, for example: at least one fork point identifying an index value of a previous point from which the current point 306B forms a fork; at least one merge point identifying an index value of a previous point from which the current point 306B forms a merge; and a set of spline coefficients 338B, among others. In the depicted example, since the current point 306B is a continuation point dependent on the point 306A and not a fork or merge, the indexes may be null. The set of spline coefficients 338B can include a set of values defining a spline curve 338′B between the point 306A and 306B. The set of spline coefficients 338B can define a pathway between the point 306A and 306B through the environment.

With the generation outputs, the computing system can use the predictors in the ML model to generate individual embeddings to form or output a set of embeddings 340A for the point 306B. Using the first point predictor 310, the computing system can determine or generate at least one corresponding embedding 330″B from the first index value 330′B. Using the second point predictor 312, the computing system can determine or generate at least one corresponding embedding 332″B from the second index value 332′B. Using the second point predictor 312, the computing system can determine or generate at least one corresponding embedding 332″B from the second index value 332′B. Using the topology type predictor 314, the computing system can determine or generate at least one corresponding embedding 334′B from the topology type 334B. Likewise, using the point attribute predictor 316, the computing system can determine or generate a set of embeddings 336′B.

Upon the generation of the individual embeddings (e.g., the embeddings 330″B, 332″B, 334′B, and 336′B), the computing system can write, produce, or otherwise generate the set of embeddings 340A. Based on the set of embeddings 340A, the computing system can produce, output, or otherwise generate at least one token 342B for at least one of the pathways through the environment. The computing system can also apply self-attention unit 318 in determining the token 342B. In some embodiments, the computing system can generate the token 342B based on the first index value 330B, the second index value 332B, the topology type 334B, or the set of point attributes 336B, or any combination thereof. With the generation, the computing system can add, insert, or otherwise include the token 342B in the graph 304. The computing system can update the graph 304 to include the token 342B to be used autonomously navigate the ego through the environment via the pathways.

Continuing onto FIG. 3F, the computing system can repeat a portion of the functionalities as described herein for a third point 306C. The computing system may correspond to the ego computing device 141 on an ego 140 or a centralized service such as the analytics server 110a. With the identification of the third point 306C, the computing system can find, determine, or otherwise identify at least one point 306C within a set of grid points in a first grid 308 defined over the environment represented by a map 310. The point 306C can correspond to a terminal point near a boundary of the map 310 and can be a point to which the ego is to navigate through the environment as defined by the map 310. The grid 308 can specify or define the set of grid points (or coordinates) at a resolution coarser or lower than an original resolution of the grid point as defined by the map 310. The map 310 can correspond to a layout of the topology surrounding the ego and can be acquired as part of the map data (e.g., navigation map 235).

The computing system can input, feed, or otherwise apply at least a portion of the vector space encoding 302 to a first point predictor unit 310. The portion of the vector space encoding 302 inputted into the first point predictor unit 310 can correspond to the point 306C defined within the set of grid points in the first grid 308 in the environment. In some embodiments, the computing system can identify or select the portion of the vector space encoding 302 to input based on the point 306C. In feeding, the computing system can process the portion of the vector space encoding 302 in accordance with the weights of the first point predictor unit 310 to calculate, determine, or otherwise generate at least one coordinate 330C corresponding to the point 306C. Using the point, the computing system can use the first point predictor unit 310 to calculate, produce, or otherwise determine a first index value 330′C for the point 306C.

The computing system can find, determine, or otherwise identify at least one point 306C within a set of grid points in a second grid 308′ defined over the environment represented by a map 312. The point 306C can correspond to the starting point from which the ego is to navigate through the environment as defined by the map 312. The second grid 308′ can specify or define the set of grid points (or coordinates) at the resolution finer or higher than the resolution of the first grid 308. The second grid 308′ can correspond to a subset of the first grid 308 surrounding or about the ego. The map 312 can correspond to a layout of the topology surrounding the ego and can be acquired as part of the map data (e.g., navigation map 235).

The computing system can input, feed, or otherwise apply at least a portion of the vector space encoding 302 and an output (e.g., embeddings derived from the first index value 330′C) of the first point predictor unit 310 to a second point predictor unit 312. The portion of the vector space encoding 302 can correspond to the point 306C defined within the set of grid points in the first grid 308′ in the environment. The portion of the vector space encoding 302 inputted into the second point prediction unit 312 can be the same or can differ from the portion of the vector space encoding 302 inputted into the first point prediction unit 310. In some embodiments, the computing system can identify or select the portion of the vector space encoding 302 to input based on the point 306C. In feeding, the computing system can process the portion of the vector space encoding 302 in accordance with the weights of the second point predictor unit 312 to calculate, determine, or otherwise generate at least one coordinate 332C corresponding to the point 306C. Using the point, the computing system can use the second point predictor unit 312 to calculate, produce, or otherwise determine a first index value 332′C for the point 306C.

The computing system can input, feed, or otherwise apply at least a portion of the vector space encoding 302 to the topology predictor unit 314. In addition, the computing system can apply an output (e.g., embeddings derived from the first index value 330′C) of the first point predictor unit 310 or an output (e.g., embeddings derived from the second index value 332′C) of the second point predictor unit 312 into the topology predictor unit 314. The portion of the vector space encoding 302 inputted into the topology predictor unit 314can be the same or can differ from the portion of the vector space encoding 302 inputted into the first point prediction unit 310 or the second point prediction unit 312.

By applying the topology predictor unit 314, the computing system can determine, category, or otherwise classify the point 306C as at least one topology type 334C. The topology type 334C can semantically specify, identify, or otherwise define a function of the point 306C with respect to a pathway along which the ego navigating through the environment as represented by the map 310. The topology type can include, for example, a start type, a continuation type, a fork type, or a terminal type, among others. In the depicted example, the topology type 334C can be a continuation type to indicate a continuation of at least one of the pathways between the point 306A and the point 306C.

The computing system can input, feed, or otherwise apply at least a portion of the vector space encoding 302 to a point attribute predictor 316. In addition, the computing system can apply an output (e.g., embeddings derived from the first index value 330′C) of the first point predictor unit 310, an output (e.g., embeddings derived from the second index value 332′C) of the second point predictor unit 312, or an output (e.g., embeddings derived from the topology type 334′C) into the point attribute predictor 316. The portion of the vector space encoding 302 inputted into the point attribute predictor 316 can be the same or can differ from the portion of the vector space encoding 302 inputted into the first point prediction unit 310, the second point prediction unit 312, or the topology predictor unit 314.

By applying the point attribute predictor 316, the computing system can generate or determine a set of point attributes 336C for the point 306C. The set of point attributes 336C can identify or include, for example: at least one fork point identifying an index value of a previous point from which the current point 306C forms a fork; at least one merge point identifying an index value of a previous point from which the current point 306C forms a merge; and a set of spline coefficients 338C, among others. In the depicted example, since the current point 306C is a continuation point dependent on the point 306A and not a fork or merge, the indexes may be null. The set of spline coefficients 338C can include a set of values defining a spline curve 338′C between the point 306A and 306C. The set of spline coefficients 338C can define a pathway between the point 306A and 306C through the environment.

In some embodiments, the computing system can also determine whether the point 306C is a terminal point toward a boundary of the map 310 based coordinates from the first grid 308 or the second grid 308′. A point may be determined to be terminal, when the coordinates of the point is within a margin of a boundary of the map 310 as defined by the first grid 308 or the second grid 308′. The terminal point can correspond to an end of the pathway (or line segment) opposite of the initial start point (e.g., point 306A). To determine, the computing system can identify the coordinates of the point 306C defined by the first grid 308 or the second grid 308′. With the identification, the computing system can compare the coordinates of the point 306C with the coordinates corresponding to the boundaries of the acquired map 310. When the coordinates of the point 306C are within a margin (e.g., equivalent to 1 m to 10 m) of the boundaries of the acquired map 310, the computing system can determine that the point 306C is a terminal point (e.g., as depicted). In addition, the computing system can determine that a pathway is defined between the point 306A and the point 306C (e.g., via the point 306B). Otherwise, when the coordinates of the point 306C are outside margin (e.g., equivalent to 1 m to 10 m) of the boundaries of the acquired map 310, the computing system can determine that the point 306C is not a terminal point (e.g., as depicted).

With the generation outputs, the computing system can use the predictors in the ML model to generate individual embeddings to form or output a set of embeddings 340A for the point 306C. Using the first point predictor 310, the computing system can determine or generate at least one corresponding embedding 330″C from the first index value 330′C. Using the second point predictor 312, the computing system can determine or generate at least one corresponding embedding 332″C from the second index value 332′C. Using the second point predictor 312, the computing system can determine or generate at least one corresponding embedding 332″C from the second index value 332′C. Using the topology type predictor 314, the computing system can determine or generate at least one corresponding embedding 334′C from the topology type 334C. Likewise, using the point attribute predictor 316, the computing system can determine or generate a set of embeddings 336′C.

Upon the generation of the individual embeddings (e.g., the embeddings 330″C, 332″C, 334′C, and 336′C), the computing system can write, produce, or otherwise generate the set of embeddings 340A. Based on the set of embeddings 340A, the computing system can produce, output, or otherwise generate at least one token 342C for at least one of the pathways through the environment. The computing system can also apply self-attention unit 318 in determining the token 342C. In some embodiments, the computing system can generate the token 342C based on the first index value 330C, the second index value 332C, the topology type 334C, or the set of point attributes 336C, or any combination thereof. With the generation, the computing system can add, insert, or otherwise include the token 342C in the graph 304. The computing system can update the graph 304 to include the token 342C to be used autonomously navigate the ego through the environment via the pathways.

Moving onto FIG. 3G, the computing system can repeat a portion of the functionalities as described herein for a fourth point 306D. The computing system may correspond to the ego computing device 141 on an ego 140 or a centralized service such as the analytics server 110a. With the identification of the fourth point 306D, the computing system can find, determine, or otherwise identify at least one point 306D within a set of grid points in a first grid 308 defined over the environment represented by a map 310. The point 306D can correspond to an intermediate point which the ego is to traverse through while navigating through the environment as defined by the map 310. The grid 308 can specify or define the set of grid points (or coordinates) at a resolution coarser or lower than an original resolution of the grid point as defined by the map 310. The map 310 can correspond to a layout of the topology surrounding the ego and can be acquired as part of the map data (e.g., navigation map 235).

The computing system can input, feed, or otherwise apply at least a portion of the vector space encoding 302 to a first point predictor unit 310. The portion of the vector space encoding 302 inputted into the first point predictor unit 310 can correspond to the point 306D defined within the set of grid points in the first grid 308 in the environment. In some embodiments, the computing system can identify or select the portion of the vector space encoding 302 to input based on the point 306D. In feeding, the computing system can process the portion of the vector space encoding 302 in accordance with the weights of the first point predictor unit 310 to calculate, determine, or otherwise generate at least one coordinate 330D corresponding to the point 306D. Using the point, the computing system can use the first point predictor unit 310 to calculate, produce, or otherwise determine a first index value 330′D for the point 306D.

The computing system can find, determine, or otherwise identify at least one point 306D within a set of grid points in a second grid 308′ defined over the environment represented by a map 312. The point 306D can correspond to the starting point from which the ego is to navigate through the environment as defined by the map 312. The second grid 308′ can specify or define the set of grid points (or coordinates) at the resolution finer or higher than the resolution of the first grid 308. The second grid 308′ can correspond to a subset of the first grid 308 surrounding or about the ego. The map 312 can correspond to a layout of the topology surrounding the ego and can be acquired as part of the map data (e.g., navigation map 235).

The computing system can input, feed, or otherwise apply at least a portion of the vector space encoding 302 and an output (e.g., embeddings derived from the first index value 330′D) of the first point predictor unit 310 to a second point predictor unit 312. The portion of the vector space encoding 302 can correspond to the point 306D defined within the set of grid points in the first grid 308′ in the environment. The portion of the vector space encoding 302 inputted into the second point prediction unit 312 can be the same or can differ from the portion of the vector space encoding 302 inputted into the first point prediction unit 310. In some embodiments, the computing system can identify or select the portion of the vector space encoding 302 to input based on the point 306D. In feeding, the computing system can process the portion of the vector space encoding 302 in accordance with the weights of the second point predictor unit 312 to calculate, determine, or otherwise generate at least one coordinate 332D corresponding to the point 306D. Using the point, the computing system can use the second point predictor unit 312 to calculate, produce, or otherwise determine a first index value 332′D for the point 306D.

The computing system can input, feed, or otherwise apply at least a portion of the vector space encoding 302 to the topology predictor unit 314. In addition, the computing system can apply an output (e.g., embeddings derived from the first index value 330′D) of the first point predictor unit 310 or an output (e.g., embeddings derived from the second index value 332′D) of the second point predictor unit 312 into the topology predictor unit 314. The portion of the vector space encoding 302 inputted into the topology predictor unit 314can be the same or can differ from the portion of the vector space encoding 302 inputted into the first point prediction unit 310 or the second point prediction unit 312.

By applying the topology predictor unit 314, the computing system can determine, category, or otherwise classify the point 306D as at least one topology type 334D. The topology type 334D can semantically specify, identify, or otherwise define a function of the point 306D with respect to a pathway along which the ego navigating through the environment as represented by the map 310. The topology type can include, for example, a start type, a continuation type, a fork type, or a terminal type, among others. In the depicted example, the topology type 334D can be a fork type to indicate a continuation of at least one of the pathways between the point 306A and the point 306D and a fork relative to the pathway defined between the point 306A and the point 306B and by extension point 306C.

The computing system can input, feed, or otherwise apply at least a portion of the vector space encoding 302 to a point attribute predictor 316. In addition, the computing system can apply an output (e.g., embeddings derived from the first index value 330′D) of the first point predictor unit 310, an output (e.g., embeddings derived from the second index value 332′D) of the second point predictor unit 312, or an output (e.g., embeddings derived from the topology type 334′D) into the point attribute predictor 316. The portion of the vector space encoding 302 inputted into the point attribute predictor 316 can be the same or can differ from the portion of the vector space encoding 302 inputted into the first point prediction unit 310, the second point prediction unit 312, or the topology predictor unit 314.

By applying the point attribute predictor 316, the computing system can generate or determine a set of point attributes 336D for the point 306D. The set of point attributes 336D can identify or include, for example: at least one fork point identifying an index value of a previous point from which the current point 306D forms a fork; at least one merge point identifying an index value of a previous point from which the current point 306D forms a merge; and a set of spline coefficients 338D, among others. In the depicted example, since the current point 306D is a fork point dependent on the point 306A, the index for the fork may refer to the index value of the point 306A. The set of spline coefficients 338D can include a set of values defining a spline curve 338′D between the point 306A and 306D. The set of spline coefficients 338D can define a pathway between the point 306A and 306D through the environment.

With the generation outputs, the computing system can use the predictors in the ML model to generate individual embeddings to form or output a set of embeddings 340A for the point 306D. Using the first point predictor 310, the computing system can determine or generate at least one corresponding embedding 330″D from the first index value 330′D. Using the second point predictor 312, the computing system can determine or generate at least one corresponding embedding 332″D from the second index value 332′D. Using the second point predictor 312, the computing system can determine or generate at least one corresponding embedding 332″D from the second index value 332′D. Using the topology type predictor 314, the computing system can determine or generate at least one corresponding embedding 334′D from the topology type 334D. Likewise, using the point attribute predictor 316, the computing system can determine or generate a set of embeddings 336′D.

Upon the generation of the individual embeddings (e.g., the embeddings 330″D, 332″D, 334′D, and 336′D), the computing system can write, produce, or otherwise generate the set of embeddings 340A. Based on the set of embeddings 340A, the computing system can produce, output, or otherwise generate at least one token 342D for at least one of the pathways through the environment. The computing system can also apply self-attention unit 318 in determining the token 342D. In some embodiments, the computing system can generate the token 342D based on the first index value 330D, the second index value 332D, the topology type 334D, or the set of point attributes 336D, or any combination thereof. With the generation, the computing system can add, insert, or otherwise include the token 342D in the graph 304. The computing system can update the graph 304 to include the token 342D to be used autonomously navigate the ego through the environment via the pathways.

Continuing onto FIG. 3H, the computing system may have repeated the functionalities above any number of times to arrive at a terminal point 306N. The computing system may correspond to the ego computing device 141 on an ego 140 or a centralized service such as the analytics server 110a. The computing system can repeat a portion of the functionalities as described herein for the point 306N. With the identification of the point 306N, the computing system may have determined the index values based on grids 308 and 308′ as described herein and may have determined the corresponding embeddings for the index values. The computing system can classify the point 306N as at least one topology type identifying an end of sentence (or end of graph) topology point. The end of sentence can correspond to a completion of the graph derived from the map 310 acquired for the surroundings of the ego. In the depicted example, the computing system can determine the point 306N as the end of sentence topology type. The computing system can finalize the generation of the graph 304 with a generation and insertion of the token for point 306N into the graph 304, in a similar manner as discussed herein. The graph 304 can be continuously generated and updated as the ego navigates through the environment.

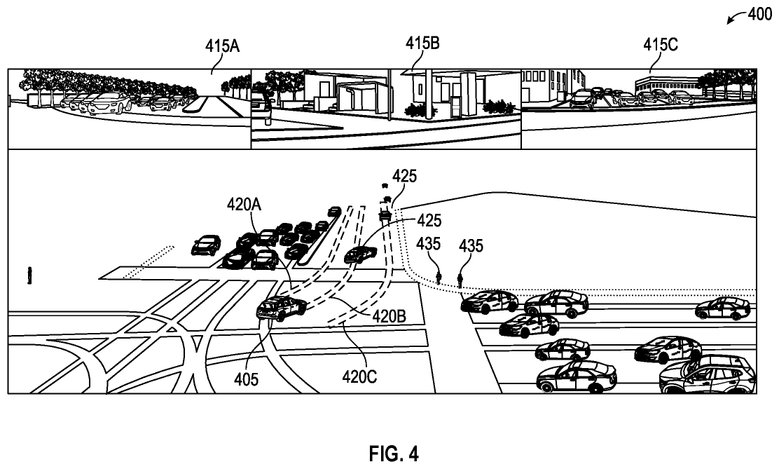

With the generation, the computing system on the ego can use the graph 304 to autonomously navigate the ego through the environment along one of the pathways defined using the set of tokens in the graph 304. The computing system can generate, calculate, or otherwise determine at least one trajectory using the set of tokens of the graph 304. The trajectory can identify, specify, or otherwise define navigation of the ego via a corresponding pathway of the set of pathways defined by the graph 304 through the environment. In determining, the computing system can monitor position and movement of the ego in the environment and select one of the set of pathways based on the position and movement (e.g., by proximity). With the selection, the computing system can project or determine the trajectory using the pathway from the position of the ego within the environment. The use of these trajectories is detailed below with respect to FIGS. 4-6.

In some embodiments, the computing system can display, render, or otherwise present the graph 304 defining the set of pathways through the environment on a graphical user interface (GUI). The set of pathways can represent potential lanes, routes, or trajectories along which the ego can navigate through the environment. The GUI can be rendered on a display communicatively coupled with the computing system, such as on a touch display screen within an autonomous vehicle (e.g., the ego). The set of pathways can be presented on the GUI as defined by the graph 304 relative to (e.g., overlaid as depicted generally along the right) the topology of the environment surrounding the ego, as defined by the map 310. Each pathway can be presented with one or more nodes and edges among the nodes. Each node can correspond to one of the points (e.g., the points 306A-N), and each edge can correspond to a line or curve between a corresponding pair of nodes using the set of spline coefficients.

Referring now to FIG. 4, depicted is a diagram of a scenario for an environment 400 in which a first ego uses a graph representing pathways to autonomously navigate through the environment. In the environment 400, an ego 405 can be navigating through an intersection of roads. As the ego 405 traverses the environment 400, cameras (and other sensors) on the ego 405 can acquire a set of videos, such as: a first video 415A from a front-left side camera; a second video 415B from a center-front camera; and a third video 415C from front-right camera. A computing device on ego 405 can also acquire map data defining various information about the topology of the environment 400. Using the acquired data, the computing device can generate a graph as detailed herein to define a set of pathways 420A-C along the road. Using the sensor data, the computing device can detect the presence of other egos 425 as well as human bystanders 435 in the environment 400. Based on these and other data, the computing device on the ego 405 can determine to autonomously navigate along the pathway 420B.

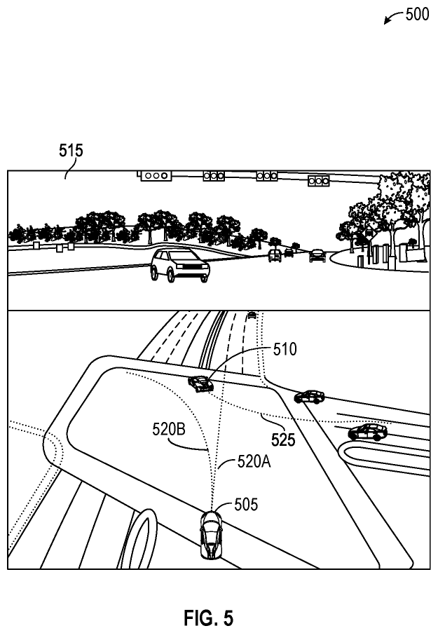

Referring now to FIG. 5, depicted is a diagram of a scenario 500 for an environment in which a first ego uses a graph to detect that a pathway that the first ego is traversing is to intersect a pathway that a second ego is about to traverse. In the environment 505, a first ego 505 and a second ego 510 (or non-autonomous vehicle) can be navigating through an intersection of roads. As the ego 505 traverses the environment 500, cameras (and other sensors) on the ego 505 can acquire at least one video 515. From the video 515, a computing device on the ego 505 can detect the presence of other egos (or vehicles on the road). In addition, the computing device on the ego 505 can generate a graph as detailed herein to define a set of pathways 520A and 520B along the road through the environment as discussed herein. In a similar manner, computing device on the ego 510 can generate a graph as detailed herein to define a pathway 525. In some embodiments, the computing device on the ego 505 can generate multiple graphs for the detected egos in the environment, including the graph defining the set of potential pathways for the ego 510.

With the generations, the computing device on the ego 505 can identify the graph generated for its own navigation through the environment. In addition, the computing device on the ego 505 can identify the graph for the other ego 510 with its own set of tokens to define autonomous navigation for the ego 510 through the environment via one or more pathways. Upon identification, the computing device can use the two graphs to determine whether a pathway 520A of the ego 505 intersects with a pathway 525 of the other ego 510. In determining, the computing device can determine a predicted trajectory for each ego 510. When the pathways do not intersect, the computing device on the ego 505 can continue to autonomously navigate along the pathway (e.g., the pathway 520A). On the other hand, if the pathways intersect, the computing device can detect or determine that the egos 505 and 510 have a potential to collide. In response to the determination, the computing device on the ego 505 (or the ego 510) can perform on action on the ego 505 (or the ego 515) to avoid the potential collision. For instance, the computing device on the ego 505 can stop propulsion of the ego 505 or alter the trajectory of the ego 505 away from the ego 515.

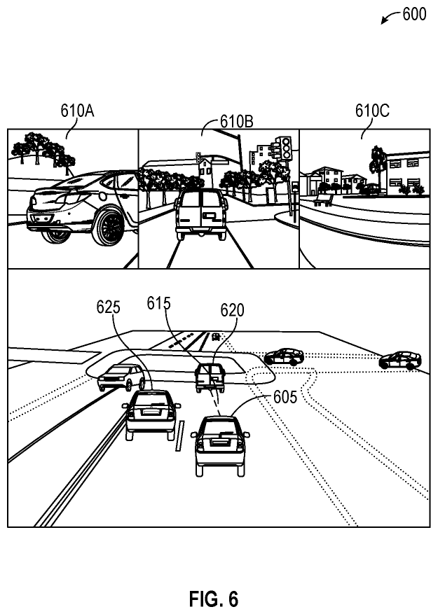

Referring now to FIG. 6, depicted is a diagram of a scenario 600 for an environment in which a first ego use a graph to detect a presence of a stationary second ego in the environment. In the environment 600, an ego 605 can be navigating along a road. As the ego 605 traverses the environment 600, cameras (and other sensors) on the ego 605 can acquire a set of videos, such as: a first video 615A from a front-left side camera; a second video 615B from a center-front camera; and a third video 615C from front-right camera. A computing device on ego 605 can also acquire map data defining various information about the topology of the environment 600. Using the acquired data, the computing device can generate a graph as detailed herein to define at least one pathway 620.

In conjunction, based on the sensor data, the computing device on the ego 605 can determine or detect the presence of other egos 620 and 625 in the environment 600. From the sensor data, the computing device can determine or identify the presence of the ego 620 that is stationary in the environment 600. With the detection, the computing device on the ego 605 can determine at least one pathway defined by the graph for the ego 605 intersects with the ego 620 identified as stationary. In response to the detection of intersection, the computing device on the ego 605 can perform an action on the ego 605 to avoid the stationary ego 620. For instance, the computing device on the ego 605 can use sensor data and map data to calculate a new trajectory to go around the ego 620 on the road. With the calculation, the computing device can control the ego 605 to take the detour trajectory.

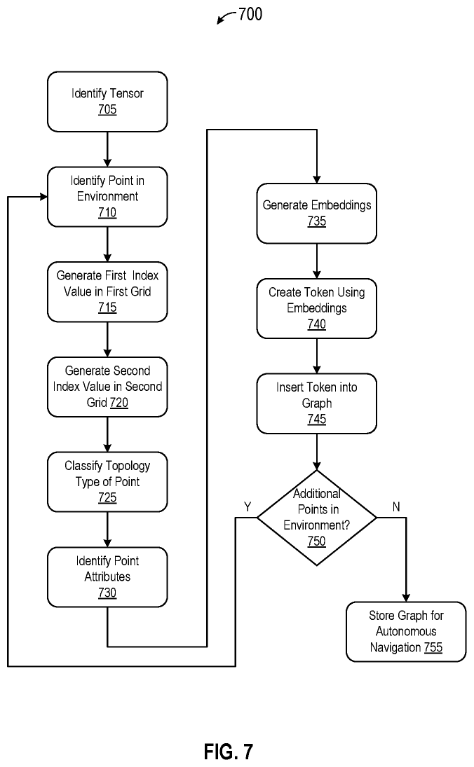

Referring now to FIG. 7, depicted is a flow diagram of a method 700 of generating pathways for autonomously navigating through an environment. The method 700 can be implemented using any of the components described herein, such as the ego computing devices 141a-c and the AI model(s) 110c. The method 700 may include steps as described herein. However, other embodiments may include additional or alternative steps or may omit one or more steps. The method 700 may be executed by an analytics server (e.g., a computer similar to the analytics server 110a) or by an ego computing device (e.g., ego computing devices 141a-c). However, one or more steps of the process 300 may be executed by any number of computing devices operating in the distributed computing system described in FIGS. 1A-C (e.g., a processor of the ego 140 and/or ego computing devices 141 or centralized service such as the analytics server 110a). For instance, one or more computing devices of an ego may locally perform some or all steps described in FIG. 7.

Under the method 700, at step 705, computing system (e.g. a processor of the ego 140 and/or ego computing devices 141 or centralized service such as the analytics server 110a) may obtain, retrieve, or otherwise identify a tensor (e.g., the vector spacing encoding 302). The sensor may include a set of encodings derived from sensor data acquired via one or more cameras and map data defining a topology of an environment surrounding the ego. The encodings may be lower dimensional representations of features in the sensor data and the map data to be used to define lane segments in the environment.

At step 710, the computing system may determine, select, or otherwise identify a point (e.g., the point 306A-N) in the environment. The point can correspond to a position, location, or a spot along which the ego is to navigate through the environment as defined by the map data. The point may be a starting point, an intermediary (or continuation) point, or a terminal point defining one or more of the potential lane segments in the environment. The map data can correspond to a layout of the topology surrounding the ego, and can be used to identify the point within the environment.

At step 715, the computing system may calculate, determine, or otherwise generate a first index value of the point in a first grid (e.g., the first grid 308) defined over the environment. The first grid can correspond to a set of grid points at a coarser or lower resolution than the original resolution of the map. To generate, the computing system may apply a portion of the tensor corresponding to the point into a first predictor unit. The first predictor unit can include a set of weights arranged in accordance with a cross-attention, a self-attention, and a transformer, among others. From applying, the computing system may determine a set of coordinates corresponding to the point within the first grid, and the first index value for the point using the set of coordinates.

At step 720, the computing system may calculate, determine, or otherwise generate a second index value of the point in a second grid (e.g., the second grid 308′) defined over the environment. The second grid can correspond to a set of grid points at a finer or higher resolution than the first grid. To generate, the computing system may apply a portion of the tensor corresponding to the point and the first index value (or an embedding derived therefrom) into a second predictor unit. The second predictor unit can include a set of weights arranged in accordance with a cross-attention, a self-attention, and a transformer, among others. From applying, the computing system may determine a set of coordinates corresponding to the point within the second grid, and the second index value for the point using the set of coordinates.

At step 725, the computing system may categorize, assign, or otherwise classify a topology type of the point. The topology type can semantically define a function of the point with respect to the lane segment along with the ego is to navigate through the environment. The topology type can include, for example, a start type, a continuation type, a fork type, or a terminal type, among others. To classify, the computing system may apply a portion of the tensor corresponding to the point, along with the first or second index value (or derivative embeddings) into a topology predictor unit. The second predictor unit can include a set of weights arranged in accordance with a cross-attention, a self-attention, and a transformer, among others. From applying, the computing system may classify the point into one of the topology types.

At step 730, the computing system may determine, generate, or otherwise identify point attributes. The point attributes may at least one fork point identifying an index value of a previous point from which the current point forms a fork; at least one merge point identifying an index value of a previous point from which the current point forms a merge; and a set of spline coefficients from another point, among others. To identify, the computing system may apply a portion of the tensor along with other outputs (e.g., embeddings derived from the index values and topology type) into a point attribute predictor. The point attribute predictor can include a set of weights arranged in accordance with a cross-attention, a self-attention, and a transformer, among others. From applying, the computing system may identify the set of point attributes.

At step 735, the computing system may produce, determine, or otherwise generate a set of embeddings using the first index value, the second index value, the topology type, and the set of point attributes. Each embedding may correspond to a respective output from the machine learning model, and may be a reduced dimensional representation of the output. The embedding may be generated from applying the weights of the models. At step 740, the computing system may write, generate, or otherwise create a token using the set of embeddings. To create the token, the computing system may combine the set of embeddings. Each token can correspond to the point defining a portion of one or more lane segments through the environment.

At step 745, the computing system may add, include, or otherwise insert the token into a graph. The graph may semantically define a set of potential lane segments along which the ego can navigate through the environment. At step 750, the computing system may determine whether there are additional points in the environment. The determination may be based on the topology type. If the topology type indicates end of sentence, the computing system may determine that there are no points to be evaluated in the environment. On the other hand, if the topology type indicates another type besides the end of sentence, the computing system may repeat the method 700 from step 710. At step 755, the computing system may store and maintain the graph. The graph may be used by the ego to perform autonomous navigation through the environment.

Additionally or alternatively, the analytics server may transmit the generated map to a downstream software application or another server. The predicted results may be further analyzed and used in various models and/or algorithms to perform various actions. For instance, a software model or a processor associated with the autonomous navigation system of the ego may receive the occupancy data predicted by the trained AI model, according to which navigational decisions may be made.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or a machine-executable instruction may represent a procedure, function, subprogram, program, routine, subroutine, module, software package, class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code, it being understood that software and control hardware can be designed to implement the systems and methods based on the description herein.

When implemented in software, the functions may be stored as one or more instructions or code on a non-transitory, computer-readable, or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitates the transfer of a computer program from one place to another. A non-transitory, processor-readable storage media may be any available media that can be accessed by a computer. By way of example, and not limitation, such non-transitory, processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that can be accessed by a computer or processor. Disk and disc, as used herein, include compact disc (CD), laser disc, optical disc, digital versatile disc (DVD), Blu-ray disc, and floppy disk, where “disks” usually reproduce data magnetically, while “discs” reproduce data optically with lasers. Combinations of the above should also be included within the scope of computer-readable media. Additionally, the operations of a method or algorithm may reside as one or any combination or set of codes and/or instructions on a non-transitory, processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method of generating pathways for autonomously navigating through an environment, comprising:
identifying, by one or more processors, a tensor comprising a plurality of encodings derived from sensor data from an ego and map data defining a topology of an environment surrounding the ego;
determining, by the one or more processors, by applying at least a first portion of the plurality of encodings to a machine learning (ML) model, a first index value defining a point within a first plurality of points of a first grid defined over the environment;
determining, by the one or more processors, by applying at least a second portion of the plurality of encodings and the first index value to the ML model, a second index value defining the point within a second plurality of points of a second grid within a subset of the first plurality of points of the first grid;
generating, by the one or more processors, a token for at least one of a plurality of pathways through the environment based on the first index value and the second index value for the point; and
storing, by the one or more processors, a graph to include the token to be used to autonomously navigate the ego through the environment via one or more of the plurality of pathways.

2. The method of claim 1, further comprising
classifying, by the one or more processors, by applying the at least a third portion of the plurality of encodings and a third index value for a second point to the ML model, the second point as a continuation topology type dependent on the first point;
determining, by the one or more processors, responsive to the classification of the second point as the continuation topology type, a plurality of spline coefficients defining a path of the plurality of pathways between the first point and the second point through the environment;
generating, by the one or more processors, a second token based on the third index point for the second point and the continuation topology type; and
updating, by the one or more processors, the graph to include the second token and the plurality of spline coefficients to be used to be used to autonomously navigate the ego through the environment.

3. The method of claim 1, further comprising:
classifying, by the one or more processors, by applying at least a third portion of the plurality of encodings and a third index value for a second point to the ML model, the second point as a forking topology type from the point relative to a third point;
determining, by the one or more processors, responsive to classifying the second point as the forking topology type, a fourth index value referencing the token for the point;
generating, by the one or more processors, a second token for a first pathway different from a second pathway associated with the third point, based on the third index value, the fourth index value, and the forking topology type; and
updating, by the one or more processors, the graph to include the second token to be used to be used to autonomously navigate the ego through the environment.

4. The method of claim 1, further comprising:
classifying, by the one or more processors, by applying at least a third portion of the plurality of encodings and a third index value for a second point to the ML model, the second point as a terminal topology type dependent on the first point;
determining, by the one or more processors, responsive to the classification of the second point as the termination topology type, a pathway defined by the first point and the second point through the environment;
generating, by the one or more processors, a second token based on the third index point for the second point and the termination topology type; and
updating, by the one or more processors, the graph to include the second token to be used to be used to autonomously navigate the ego through the environment.

5. The method of claim 1, further comprising
identifying, by the one or more processors, a second graph comprising a plurality of tokens to be used to autonomously navigate a second ego through the environment via one or more of a second plurality of pathways;
determining, by the one or more processors, using the graph and the second graph, that at least one first pathway of the plurality of pathways for the ego intersects with at least one second pathway of the second plurality of pathways for the second ego; and
performing, by the one or more processors, an action on at least one of the ego or the second ego responsive to determining that at least one first pathway intersects with the second pathway.

6. The method of claim 1, further comprising:
identifying, by the one or more processors, using the sensor data from the ego, a presence of a second ego stationary in the environment; and
determining, by the one or more processors, using the graph, that at least one first pathway of the plurality of pathways for the ego intersects with the stationary second ego.

7. The method of claim 1, further comprising classifying, by the one or more processors, by applying at least a third portion of the plurality of encodings and the second index value to the ML model, the point as a topology type indicating a start of at least one of the plurality of pathways, and
wherein generating the token further comprises generating the token for at least one of the plurality of pathways through the environment based on the topology type.

8. The method of claim 1, further comprising determining, by the one or more processors, using a plurality of tokens of the graph, a trajectory defining navigation of the ego via a pathway of the plurality of pathways through the environment.

9. The method of claim 1, further comprising presenting, by the one or more processors, via a graphical user interface (GUI), the graph defining the plurality of pathways relative to the topology of the environment surrounding the ego.

10. The method of claim 1, wherein generating the token further comprises generating the token using (i) a first embedding generated from the first index value, (ii) a second embedding generated from the second index value, and (iii) one or more embeddings associated with the point.

11. A system for generating pathways for autonomously navigating through an environment, comprising:
one or more processors coupled with memory, configured to:
identify a tensor comprising a plurality of encodings derived from sensor data from an ego and map data defining a topology of an environment surrounding the ego;
determine, by applying at least a first portion of the plurality of encodings to a machine learning (ML) model, a first index value defining a point within a first plurality of points of a first grid defined over the environment;
determine, by applying at least a second portion of the plurality of encodings and the first index value to the ML model, a second index value defining the point within a second plurality of points of a second grid within a subset of the first plurality of points of the first grid;
generate a token for at least one of a plurality of pathways through the environment based on the first index value and the second index value for the point; and
store a graph to include the token to be used to autonomously navigate the ego through the environment via one or more of the plurality of pathways.

12. The system of claim 11, wherein the one or more processors are further configured to
classify, by applying at least a third portion of the plurality of encodings and a third index value for a second point to the ML model, the second point as a continuation topology type dependent on the first point;
determine, responsive to the classification of the second point as the continuation topology type, a plurality of spline coefficients defining a path of the plurality of pathways between the first point and the second point through the environment;
generate a second token based on the third index point for the second point and the continuation topology type; and
update the graph to include the second token and the plurality of spline coefficients to be used to be used to autonomously navigate the ego through the environment.

13. The system of claim 11, wherein the one or more processors are further configured to:
classify, by applying at least a third portion of the plurality of encodings and a third index value for a second point to the ML model, the second point as a forking topology type from the point relative to a third point;
determine, responsive to classifying the second point as the forking topology type, a fourth index value referencing the token for the point;
generate a second token for a first pathway different from a second pathway associated with the third point, based on the third index value, the fourth index value, and the forking topology type; and
update the graph to include the second token to be used to be used to autonomously navigate the ego through the environment.

14. The system of claim 11, wherein the one or more processors are further configured to:
classify, by applying at least a third portion of the plurality of encodings and a third index value for a second point to the ML model, the second point as a terminal topology type dependent on the first point;
determine, responsive to the classification of the second point as the termination topology type, a pathway defined by the first point and the second point through the environment;
generate a second token based on the third index point for the second point and the termination topology type; and
update the graph to include the second token to be used to be used to autonomously navigate the ego through the environment.

15. The system of claim 11, wherein the one or more processors are further configured to:
identify a second graph comprising a plurality of tokens to be used to autonomously navigate a second ego through the environment via one or more of a second plurality of pathways;
determine, using the graph and the second graph, that at least one first pathway of the plurality of pathways for the ego intersects with at least one second pathway of the second plurality of pathways for the second ego; and
perform an action on at least one of the ego or the second ego responsive to determining that at least one first pathway intersects with the second pathway.

16. The system of claim 11, wherein the one or more processors are further configured to:
identify, using the sensor data from the ego, a presence of a second ego stationary in the environment; and
determine, using the graph, that at least one first pathway of the plurality of pathways for the ego intersects with the stationary second ego.

17. The system of claim 11, wherein the one or more processors are further configured to:
classify, by applying at least a third portion of the plurality of encodings and the second index value to the ML model, the point as a topology type indicating a start of at least one of the plurality of pathways, and
generate the token for at least one of the plurality of pathways through the environment based on the topology type.

18. The system of claim 11, wherein the one or more processors are further configured to determine, using a plurality of tokens of the graph, a trajectory defining navigation of the ego via a pathway of the plurality of pathways through the environment.

19. The system of claim 11, wherein the one or more processors are further configured to present, via a graphical user interface (GUI), the graph defining the plurality of pathways relative to the topology of the environment surrounding the ego.

20. The system of claim 11, wherein the one or more processors are further configured to generate the token using (i) a first embedding generated from the first index value, (ii) a second embedding generated from the second index value, and (iii) one or more embeddings associated with the point.
